(19) United States
(12) Patent Application Publication
(10) Pub. No.: US 2024/0382959 A1
(43) Pub. Date: Nov. 21, 2024

(54) LIQUID DELIVERY APPARATUS

(71) Applicants: CANON MEDICAL SYSTEMS CORPORATION, Otawara-shi (JP); Canon Kabushiki Kaisha, Tokyo (JP)

(72) Inventors: Kohei SARUWATARI, Kawasaki (JP); Kenta KAMINO, Utsunomiya (JP); Yusuke OWAKI, Mooka (JP)

(73) Assignees: CANON MEDICAL SYSTEMS CORPORATION, Otawara-shi (JP); Canon Kabushiki Kaisha, Tokyo (JP)

(21) Appl. No.: 18/659,104

(22) Filed: May 9, 2024

(30) Foreign Application Priority Data
May 18, 2023 (JP) 2023-081972

(51) Int. Cl. B01L 3/00

(52) U.S. Cl. CPC B01L 3/502761; B01L 2200/027; B01L 2200/0647; B01L 2200/0673; B01L 2300/0681; B01L 2400/0487

(57) ABSTRACT

A liquid delivery apparatus according to an embodiment is provided with a reservoir part, a pipe, and a liquid delivery part. The reservoir part stores therein a first liquid and a second liquid that is immiscible with the first liquid and has a different specific gravity from that of the first liquid. One end of the pipe is coupled to the reservoir part and the other end thereof is coupled to a liquid delivery destination of the first liquid. The liquid delivery part extrudes the first liquid and the second liquid in this order from the reservoir part to the pipe to deliver the first liquid to the liquid delivery destination.

### CROSS-REFERENCE TO RELATED APPLICATIONS

This application is based upon and claims the benefit of priority from Japanese Patent Application No. 2023-081972, filed on May 18, 2023, the entire contents of which are incorporated herein by reference.

### FIELD

Embodiments described herein relate generally to a liquid delivery apparatus.

### BACKGROUND

Microfluidic devices have been known to be provided with channels in size of μm (hereinbelow, also referred to as microchannels) and perform cell sorting and analysis, formation of micro-reaction fields (hereinbelow, also referred to as droplet formation), and the like. In such microfluidic devices, a syringe containing a sample solution, which is a specimen, is connected to a microchannel via a pipe (for example, a tube or the like) to deliver the specimen into the microchannel by a pump or the like.

### BRIEF DESCRIPTION OF THE DRAWINGS

FIG. 1 is a block diagram illustrating an example of a configuration of a liquid delivery system according to a first embodiment;

FIG. 2 is a diagram illustrating an example of processing of calculating an estimated dead volume according to the first embodiment;

FIG. 3 is a block diagram illustrating an example of a configuration of a liquid delivery apparatus and a drive apparatus according to the first embodiment;

FIG. 4 is a perspective view illustrating an example of the appearance of the liquid delivery apparatus according to the first embodiment;

FIG. 5 is a perspective view illustrating an example of the appearance of the liquid delivery apparatus according to the first embodiment;

FIG. 6 is a flowchart illustrating an example of processing executed by the liquid delivery system according to the first embodiment;

FIG. 7 is a diagram illustrating an example of an operation of the liquid delivery apparatus according to the first embodiment;

FIG. 8 is a diagram illustrating an example of an operation of the liquid delivery apparatus according to the first embodiment;

FIG. 9 is an image diagram illustrating an example of an apparatus configuration in a comparative evaluation of the liquid delivery apparatus according to the first embodiment;

FIG. 10 is a diagram illustrating an example of data of the comparative evaluation on the liquid delivery stability of the liquid delivery apparatus according to the first embodiment;

FIG. 11 is a block diagram illustrating an example of a configuration of a liquid delivery apparatus and a drive apparatus according to a second embodiment;

FIG. 12 is a perspective view illustrating an example of the appearance of the liquid delivery apparatus according to the second embodiment;

FIG. 13 is a perspective view illustrating an example of the appearance of the liquid delivery apparatus according to the second embodiment;

FIG. 14 is a perspective view illustrating an example of the appearance of the liquid delivery apparatus according to the second embodiment;

FIG. 15 is a flowchart illustrating an example of processing executed by a liquid delivery system according to the second embodiment;

FIG. 16 is a block diagram illustrating an example of a configuration of a liquid delivery apparatus and a drive apparatus according to a third embodiment;

FIG. 17 is a perspective view illustrating an example of the appearance of the liquid delivery apparatus according to the third embodiment;

FIG. 18 is a perspective view illustrating an example of the appearance of the liquid delivery apparatus according to the third embodiment;

FIG. 19 is a perspective view illustrating an example of the appearance of the liquid delivery apparatus according to the third embodiment;

FIG. 20 is a perspective view illustrating an example of the appearance of the liquid delivery apparatus according to the third embodiment;

FIG. 21 is a flowchart illustrating an example of processing executed by the liquid delivery system according to the first embodiment;

FIG. 22 is a schematic diagram illustrating an example of a configuration of a microchannel according to a first modification;

FIG. 23 is a diagram illustrating an example of processing of calculating the estimated dead volume according to the first modification;

FIG. 24 is a diagram illustrating an example of an operation of the liquid delivery apparatus according to a second modification;

FIG. 25 is a diagram illustrating an example of experimental data on the liquid delivery stability of the liquid delivery apparatus according to the second modification;

FIG. 26 is a block diagram illustrating an example of a configuration of the liquid delivery system according to a third modification;

FIG. 27 is a perspective view illustrating an example of the appearance of the liquid delivery apparatus according to a fourth modification;

FIG. 28 is a perspective view illustrating an example of the appearance of the liquid delivery apparatus according to the fourth modification;

FIG. 29 is a perspective view illustrating an example of the appearance of the liquid delivery apparatus according to the fourth modification;

FIG. 30 is a perspective view illustrating an example of the appearance of the liquid delivery apparatus according to the fourth modification;

FIG. 31 is a diagram illustrating an example of an operation of a liquid delivery apparatus in a different form from the embodiment;

FIG. 32 is a diagram illustrating an example of an operation of the liquid delivery apparatus in the different form from the embodiment; and

FIG. 33 is an image diagram illustrating an example of an apparatus configuration in a comparative evaluation of the liquid delivery apparatus in the different form from the embodiments.

### DETAILED DESCRIPTION

A liquid delivery apparatus according to the present embodiment is provided with a reservoir part, a pipe, and a liquid delivery part. The reservoir part stores therein a first liquid and a second liquid that is immiscible with the first liquid and has a different specific gravity from that of the first liquid. One end of the pipe is coupled to the reservoir part and the other end thereof is coupled to a liquid delivery destination of the first liquid. The liquid delivery part extrudes the first liquid and the second liquid in this order from the reservoir part to the pipe to deliver the first liquid to the liquid delivery destination.

Hereinbelow, some embodiments of the liquid delivery apparatus are described in detail with reference to the drawings. The embodiments are not limited to the following embodiments. In the following description, the same reference letters and numerals are given to the same components, and duplicated descriptions are not repeated.

### First Embodiment

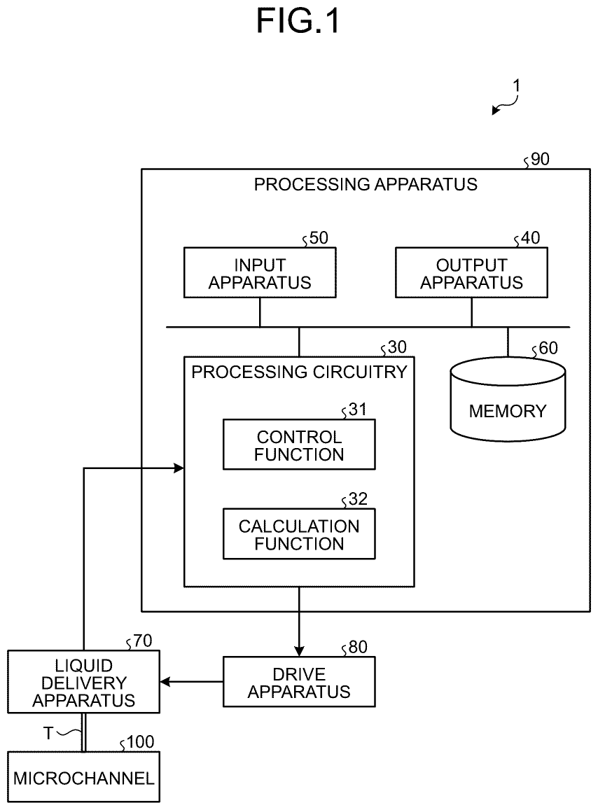

FIG. 1 is a block diagram illustrating an example of a configuration of a liquid delivery system 1 according to a first embodiment. The liquid delivery system 1 illustrated in FIG. 1 is an example of the liquid delivery apparatus. The liquid delivery system 1 according to the present embodiment is provided with a liquid delivery apparatus 70, a drive apparatus 80, a processing apparatus 90, and a microchannel 100. The microchannel 100 is an example of a microfluidic channel.

The liquid delivery apparatus 70 and the microchannel 100 are connected via a tube T. The tube T is, for example, a polytetrafluoroethylene (PTFE) tube. The tube T is an example of the pipe.

The liquid delivery apparatus 70 delivers a liquid (hereinbelow, also referred to as a sample solution) containing a sample (such as a biological specimen containing target cells to be cultured) to the microchannel 100. For example, the liquid delivery apparatus 70 continuously delivers a cell suspension containing the sample (hereinbelow, also referred to simply as a cell suspension) to the microchannel 100 at a predetermined flow rate. The liquid delivery apparatus 70 may be provided with a unit that dispenses a reagent to the microchannel 100. In this case, the liquid delivery apparatus 70 is formed of a plurality of units, including a unit that delivers the sample solution.

The drive apparatus 80 drives the liquid delivery apparatus 70. The drive apparatus 80 is formed of a drive source such as a pump or a motor, for example.

The processing apparatus 90 controls the drive apparatus 80 to operate the liquid delivery apparatus 70. The processing apparatus 90 includes an output apparatus 40, an input apparatus 50, a memory 60, and processing circuitry 30.

The output apparatus 40 outputs various pieces of information. The output apparatus 40 is provided with a printer and a display. The printer prints data and other information related to the liquid delivery. The display is a monitor such as a cathode ray tube (CRT) or a liquid crystal panel and displays data and other information related to the liquid delivery.

The input apparatus 50 inputs various pieces of information. The input apparatus 50 is provided with input devices such as a keyboard, a mouse, buttons, and a touch keypad panel, and performs an input of setting parameters related to the liquid delivery, such as a volume of a cell suspension SL to be delivered, a delivery flow rate, and others, an input of setting the identification information of the sample being tested, and the like.

The memory 60 stores therein various pieces of information. The memory 60 is, for example, a semiconductor memory device such as a random-access memory (RAM) or a flash memory, or a storage apparatus such as a hard disk or an optical disc.

The processing circuitry 30 provides the overall control of the entire liquid delivery system 1. For example, the processing circuitry 30 performs a control function 31 and a calculation function 32, as illustrated in FIG. 1.

The control function 31 controls the drive apparatus 80 to operate the various apparatuses of the liquid delivery system 1. For example, the control function 31 drives a liquid delivery drive source (for example, a pump) included in the drive apparatus 80 to deliver, into the microchannel 100, the cell suspension with which a sample supply part 71 described later is filled.

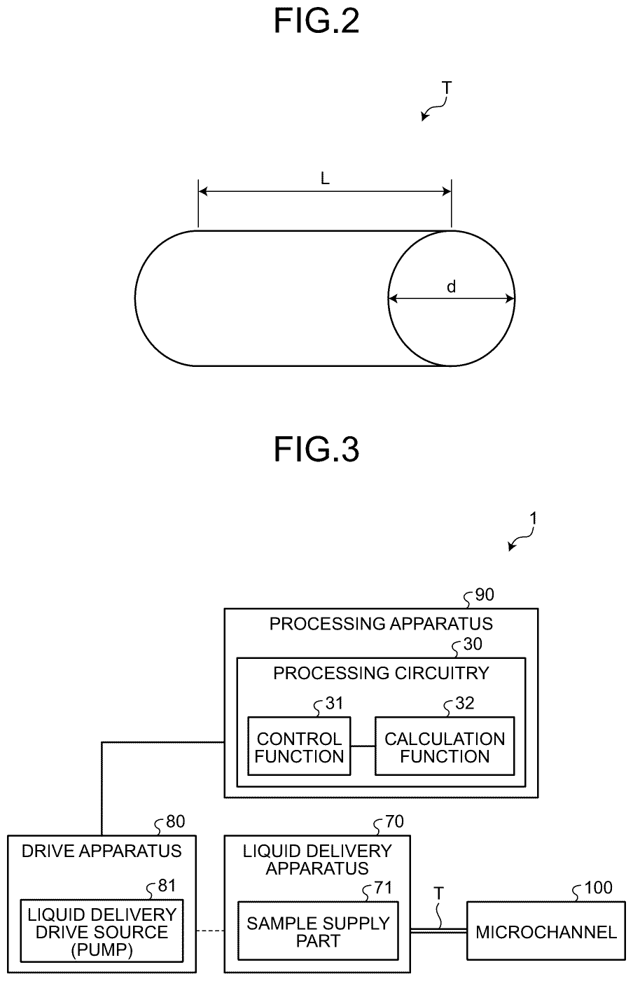

The calculation function 32 calculates an estimated dead volume in the pipe based on information of the pipe. For example, the calculation function 32 calculates an estimated dead volume in the tube T. As an example, the calculation function 32 calculates the estimated dead volume based on information on the tube T (for example, the inner diameter and the length of the tube). Hereinbelow, processing of calculating the estimated dead volume in the pipe will be described with reference to FIG. 2.

FIG. 2 is a diagram illustrating an example of processing of calculating the estimated dead volume in the pipe. The estimated dead volume in the pipe is calculated by an estimation equation expressed with a pipe cross-sectional area×a pipe length. The example in FIG. 2 illustrates the case in which the inner diameter of the tube T is denoted by d, and the length of the tube T is denoted by L. In this case, an estimated dead volume DV1 in the tube T can be calculated by the equation DV1=πd2/4×L. In this case, the inner diameter of the tube T and the length of the tube T are examples of information on the pipe.

The control function 31 described above causes the cell suspension and a dead volume countermeasure liquid to be delivered into the microchannel 100 based on the estimated dead volume calculated by the calculation function 32. The processing of delivering the cell suspension by the control function 31 is described later.

Here, for example, each processing function performed by the components of the processing circuitry 30 is recorded in the memory 60 in the form of a computer program executable by a computer. The processing circuitry 30 is a processor that reads each computer program from the memory 60 and executes the computer program to implement a function corresponding to each computer program. In other words, the processing circuitry 30 with each computer program read will have each function in the processing circuitry 30 illustrated in FIG. 1.

It is described in FIG. 1 that a single piece of the processing circuitry 30 implements each of the processing functions described later, but a processing circuit that is formed in a combination of a plurality of independent processors each of which executes a computer program to implement the functions may also be adopted.

The term “processor” as used in the above explanation refers to, for example, circuitry such as a central processing unit (CPU), a graphics processing unit (GPU), an application specific integrated circuit (ASIC), a programmable logic device (for example, simple programmable logic device (SPLD)), a complex programmable logic device (CPLD), or a field programmable gate array (FPGA).

When the processor is, for example, a CPU, the processor reads and executes the computer program stored in the memory 60 to implement the functions. On the other hand, when the processor is, for example, an ASIC, the computer program is incorporated directly into circuitry of the processor instead of storing the computer program in the memory 60.

Each processor of the present embodiment is not limited to the case in which each processor is configured as a single piece of circuitry, and may also be configured as a single processor formed with a combination of a plurality of pieces of independent circuitry to implement the functions thereof. Furthermore, a plurality of the components in FIG. 1 may be integrated into a single processor to implement the functions thereof.

Returning to FIG. 1, the explanation will be continued. The microchannel 100 is where processing, such as cell sorting or droplet formation, is performed on the sample. For example, when the cell sorting is performed, the microchannel 100 performs processes such as separating, sorting, and collecting cells based on the size.

For example, when droplet formation is performed, the microchannel 100 performs processes such as chemical reaction, protein crystallization, particulate synthesis, polymer synthesis, and monodispersity of single cells. In this case, the control function 31 of the processing circuitry 30 described above may control the flow rate of the sample solution to adjust a droplet size and throughput (frequency of the formation).

The microchannel 100 may be changed according to the processing and the like to be executed. In this case, the tube T may be changed together.

Next, the liquid delivery apparatus 70 and the drive apparatus 80 will be described with reference to FIGS. 3 to 5. FIG. 3 is a block diagram illustrating an example of a configuration of the liquid delivery apparatus 70 and the drive apparatus 80 in the liquid delivery system 1 according to the first embodiment.

As illustrated in FIG. 3, the liquid delivery apparatus 70 has a sample supply part 71. In addition, the drive apparatus 80 has a liquid delivery drive source 81. The liquid delivery drive source 81 is an example of the liquid delivery part, a first filling part, and a second filling part. As illustrated also in FIG. 1, the processing circuitry 30 of the processing apparatus 90 has the control function 31 and the calculation function 32 as functional parts. The sample supply part 71 is connected to the microchannel 100 via the tube T.

The sample supply part 71 stores therein the cell suspension containing the target cells and the dead volume countermeasure liquid that is immiscible with the cell suspension and has a different specific gravity from that of the cell suspension. The cell suspension containing the target cells is an example of the first liquid. The dead volume countermeasure liquid is an example of the second liquid. The sample supply part 71 is, for example, a syringe or the like. The sample supply part 71 is an example of the reservoir part since the sample supply part 71 stores therein the cell suspension and the dead volume countermeasure liquid.

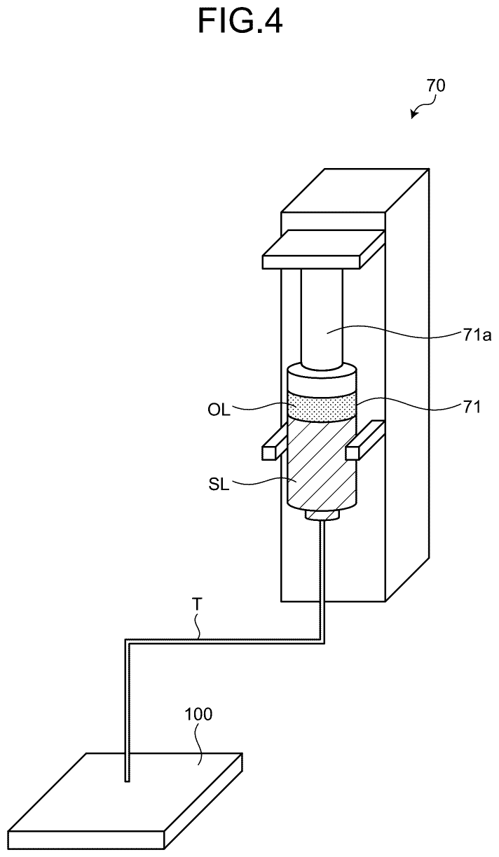

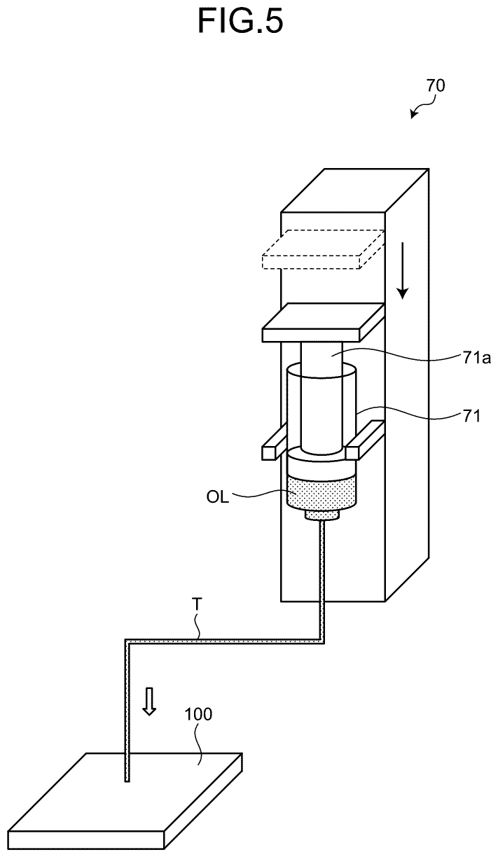

The cell suspension and the dead volume countermeasure liquid are extruded from the sample supply part 71 in this order into the tube T under the control of the control function 31 of the processing circuitry 30, so that the cell suspension is delivered to the microchannel 100. The microchannel 100 in this case is an example of the liquid delivery destination. In the present embodiment, the sample supply part 71 is secured so that a liquid delivery direction is oriented downwards. For example, the sample supply part 71 is secured by, for example, the liquid delivery drive source 81 of the drive apparatus 80 so that the liquid delivery direction is almost vertically downward, as illustrated in FIGS. 4 and 5.

In FIGS. 4 and 5, the liquid delivery direction is exemplified to be substantially vertically oriented downwards, but the liquid delivery direction is not limited to the substantially vertically downward direction. The liquid delivery direction may be any direction if among vector components in the liquid delivery direction, the vector component in the gravity direction is greater than the vector components in the directions other than the gravity direction. For example, the liquid delivery direction may be diagonally downward or other directions, if among the vector components in the liquid delivery direction, the vector component in the gravity direction is greater than the vector components in the directions other than the gravity direction.

The liquid delivery drive source 81 is an apparatus that generates the driving force to supply the cell suspension and the dead volume countermeasure liquid in the sample supply part 71 to the microchannel 100. The liquid delivery drive source 81 is, for example, a syringe pump.

The control function 31 also controls the liquid delivery drive source 81 to supply the cell suspension to the microchannel 100 at a predetermined flow rate.

The calculation function 32 calculates the estimated dead volume in the tube T by the method described in FIG. 2. The control function 31 controls the liquid delivery drive source 81 to extrude the cell suspension out of the sample supply part 71, followed by the extrusion of the dead volume countermeasure liquid from the sample supply part 71 into the tube T based on the estimated dead volume calculated by the calculation function 32 so that no cell suspension remains in the tube T.

FIGS. 4 and 5 are herein perspective views illustrating examples of the appearance of the liquid delivery apparatus 70 according to the first embodiment. FIG. 4 illustrates an example of the liquid delivery apparatus 70 in the state prior to supply of the cell suspension SL into the microchannel 100.

As illustrated in FIG. 4, the sample supply part 71 has a plunger 71a. The sample supply part 71 is also connected to the microchannel 100 via the tube T. For example, a coupling member (for example, a luer lock and other members) that couples the tube T to the sample supply part 71 is provided at the tip end thereof, thereby one end of the tube T being coupled to the sample supply part 71 in an attachable and detachable manner by the coupling member. The microchannel 100 is coupled to other end of the tube T.

The plunger 71a is moved up and down by the liquid delivery drive source 81 being driven to perform suction and extrusion of the liquid stored in the sample supply part 71. Specifically, the plunger 71a extrudes, by the liquid delivery drive source 81 being driven, the cell suspension SL and a dead volume countermeasure liquid OL in the sample supply part 71 to be supplied to the tube T. In the present embodiment, the sample supply part 71 is pre-filled with the cell suspension SL and the dead volume countermeasure liquid OL.

Here, the volume of the cell suspension SL present in the sample supply part 71 is input by a user in advance through the input apparatus 50. The volume of the cell suspension SL present in the sample supply part 71 represents the total volume of the cell suspension SL to be delivered into the microchannel 100.

Similarly, a set value of the delivery flow rate is also input by the user in advance through the input apparatus 50. The delivery flow rate represents the amount of the cell suspension SL to be delivered per minute. A method of setting the delivery flow rate is not limited to the user input. For example, the control function 31 may automatically set the delivery flow rate according to the setting of processing or the like performed in the microchannel 100.

The volume of the dead volume countermeasure liquid OL with which the sample supply part 71 is filled is equal to or greater than the estimated dead volume calculated by the calculation function 32. A lack of the dead volume countermeasure liquid OL is accordingly prevented from extruding air into the tube T instead of the dead volume countermeasure liquid OL.

Here, the cell suspension SL is a liquid medium such as Roswell Park Memorial Institute (RPMI)-1640 medium used for cell culture. As the dead volume countermeasure liquid OL, a liquid with a specific gravity that depends on the liquid delivery direction is used. In a case in which the liquid delivery direction is downward, a liquid has a lower specific gravity than that of the cell suspension SL. In the present embodiment, the dead volume countermeasure liquid OL is an oil with a lower specific gravity than that of the cell suspension SL. Examples of the oil with a lower specific gravity than that of the cell suspension SL include canola oil.

Since the dead volume countermeasure liquid OL with a lower specific gravity than that of the cell suspension SL is used, the cell suspension SL with a high specific gravity is placed on the lower side of the sample supply part 71, and the dead volume countermeasure liquid OL with a low specific gravity is placed on the upper side, as illustrated in FIG. 4.

In the present embodiment, the user places a syringe filled with the cell suspension SL containing the target cells and the dead volume countermeasure liquid OL into the liquid delivery apparatus 70. The syringe in this case is an example of the sample supply part 71. The user oneself may fill the empty syringe with the cell suspension SL containing the target cells and the dead volume countermeasure liquid OL using a pipette, filling syringe, a tube, or the like.

FIG. 5 illustrates an example of the state of the liquid delivery apparatus 70 after the cell suspension SL is supplied to the microchannel 100. The control function 31 drives the liquid delivery drive source 81 to cause the plunger 71a to move downwards, as illustrated in FIG. 5. The cell suspension SL is accordingly extruded from the sample supply part 71 into the tube T. When the plunger 71a further moves downwards, the cell suspension SL is delivered from the tube T into the microchannel 100.

When the entire cell suspension SL in the sample supply part 71 is extruded into the tube T, the tube T is filled with the cell suspension SL. Here, in a case in which there is no dead volume countermeasure liquid OL in the sample supply part 71, the cell suspension SL remains in the tube T. In other words, the dead volume (liquid residue) occurs in the tube T.

In the present embodiment, the liquid delivery drive source 81 is driven by the control function 31 to cause the dead volume countermeasure liquid OL in the sample supply part 71 to extrude the cell suspension SL remaining in the tube T. The cell suspension SL in the tube T is accordingly delivered into the microchannel 100.

The control function 31 controls the drive of the liquid delivery drive source 81 so that the dead volume countermeasure liquid OL with a volume equivalent to the estimated dead volume calculated by the calculation function 32 is extruded into the tube T. In other words, in this case, it can be said that the calculation function 32 calculates the volume of the dead volume countermeasure liquid OL to be extruded into the tube T based on the information of the tube T.

In the present embodiment, the liquid delivery drive source 81 is driven by the control function 31 to cause the dead volume countermeasure liquid OL with a volume equivalent to the estimated dead volume calculated by the calculation function 32 to extrude the cell suspension SL remaining in the tube T. Since the volume of the dead volume countermeasure liquid OL extruded into the tube T is the same volume as the estimated dead volume calculated by the calculation function 32, the total volume of the dead volume countermeasure liquid OL remains in the tube T according to the calculation, and the dead volume countermeasure liquid OL is not extruded into the microchannel 100.

Accordingly, the liquid delivery apparatus 70 according to the present embodiment prevents the dead volume countermeasure liquid OL from entering the microchannel 100, which enables the control of the dead volume in the tube T.

In the present embodiment, the control function 31 causes the dead volume countermeasure liquid OL with a volume equivalent to the estimated dead volume calculated by the calculation function 32 to be extruded into the tube T, but the volume of the dead volume countermeasure liquid OL extruded into the tube T is not limited thereto. For example, a volume equivalent to a value obtained by subtracting a predetermined value from the estimated dead volume may be used as the volume of the dead volume countermeasure liquid OL to be extruded into the tube T, and a volume equivalent to a value obtained by adding a predetermined value to the estimated dead volume may be used as the volume of the dead volume countermeasure liquid OL to be extruded into the tube T.

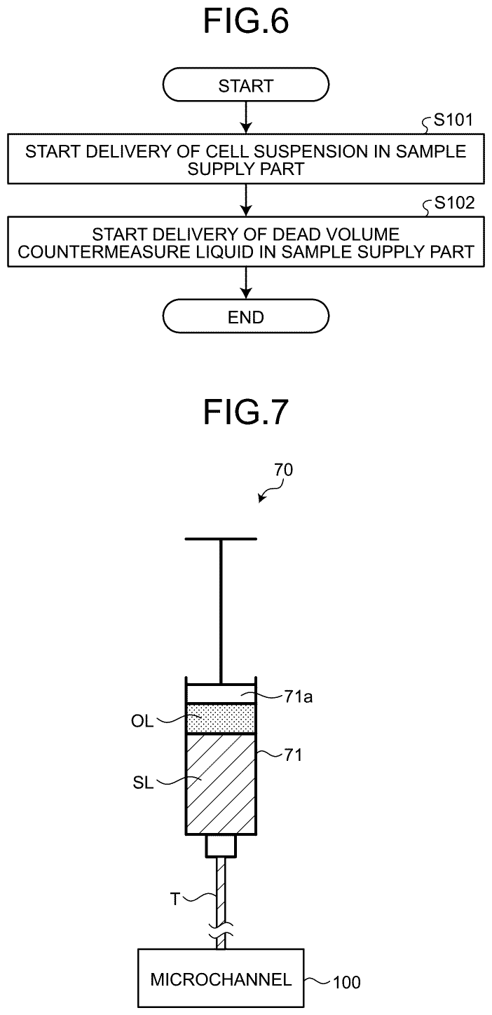

Next, processing executed by the liquid delivery system 1 according to the present embodiment will be described. FIG. 6 is a flowchart illustrating an example of processing executed by the liquid delivery system 1 according to the first embodiment.

As a precondition for this processing, it is assumed that the calculation function 32 has already calculated the estimated dead volume of the tube T. It is assumed that the control function 31 has already set a delivery volume of the dead volume countermeasure liquid OL based on the estimated dead volume of the tube T, which has been calculated. It is also assumed that the sample supply part 71 that has already been filled with the cell suspension SL and the dead volume countermeasure liquid OL is installed on the liquid delivery apparatus 70. It is further assumed that the volume and delivery flow rate of the cell suspension SL in the sample supply part 71 are set in advance.

The control function 31 starts the delivery of the cell suspension SL in the sample supply part 71 (step S101).

For example, the control function 31 controls the liquid delivery drive source 81 to press the plunger 71a downwards and extrude the cell suspension SL in the sample supply part 71 into the tube T to achieve a predetermined flow rate. The control function 31 further allows the downward pressure to be applied to the plunger 71a to deliver the cell suspension SL in the tube T into the microchannel 100.

Next, the control function 31 starts the delivery of the dead volume countermeasure liquid OL in the sample supply part 71 (step S102) and completes this process.

For example, after the total volume of the cell suspension SL in the sample supply part 71 is extruded into the tube T according to the calculation, the control function 31 causes the dead volume countermeasure liquid OL in the sample supply part 71, equivalent to the estimated dead volume of the tube T calculated by the calculation function 32, to be extruded into the tube T.

The approximate total volume of the cell suspension SL with which the sample supply part 71 is filled can be accordingly delivered into the microchannel 100.

The liquid delivery system 1 according to the first embodiment described above is provided with the sample supply part 71 filled with the cell suspension SL and the dead volume countermeasure liquid OL that is immiscible with the cell suspension SL and has a different specific gravity from that of the cell suspension SL, and the tube T whose one end is coupled to the sample supply part 71 and the other end is coupled to the microchannel 100. In addition, the liquid delivery system 1 extrudes the cell suspension SL and the dead volume countermeasure liquid OL in this order from the sample supply part 71 to the tube T to deliver the cell suspension SL to the microchannel 100.

The cell suspension SL remaining in the tube T at the time of extrusion of the cell suspension SL in the sample supply part 71 can be accordingly delivered into the microchannel 100 by extrusion of the dead volume countermeasure liquid OL. In other words, the liquid delivery system 1 according to the present embodiment can control the dead volume. Hereinbelow, the reason why the dead volume can be controlled will be described with reference to the drawings.

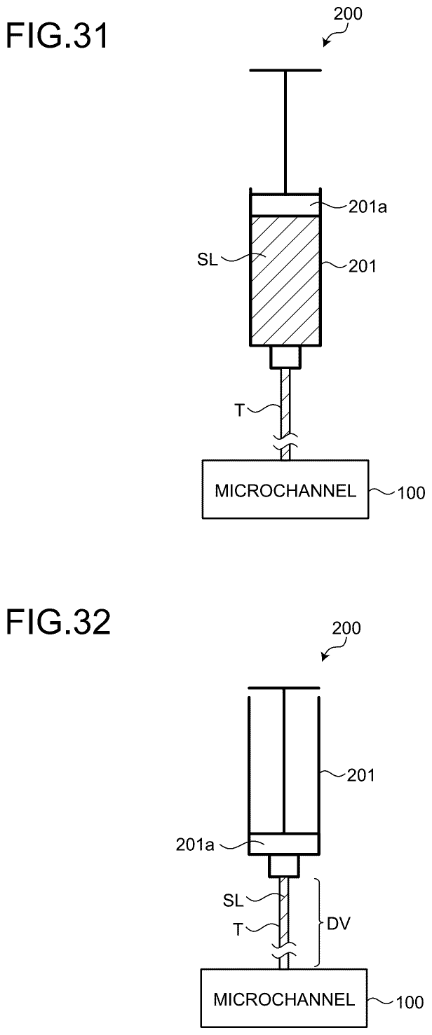

First, for the comparison with a liquid delivery method according to the present embodiment, a liquid delivery apparatus configured to have no dead volume countermeasure liquid OL will be described. FIGS. 31 and 32 are diagrams illustrating examples of operations of a liquid delivery apparatus 200 having a different configuration from the embodiment. The liquid delivery apparatus 200 has a sample supply part 201 and a plunger 201a. Since the sample supply part 201 and the plunger 201a are similar to the sample supply part 71 and the plunger 71a, the descriptions thereof will not be repeated. The sample supply part 201 is connected to the microchannel 100 via the tube T.

It is illustrated in FIG. 31 that the cell suspension SL with which the sample supply part 201 is filled is in the state prior to the delivery into the microchannel 100. For example, the liquid delivery drive source (not illustrated) such as a pump is driven to push the plunger 201a downwards to extrude the cell suspension SL into the tube T. By the plunger 201a being pushed down, the delivery of the cell suspension SL into the microchannel 100 can be achieved.

It is also illustrated in FIG. 32 that the plunger 201a has been pushed down to the bottom of the sample supply part 201. As illustrated in FIG. 32, the extrusion force of the plunger 201a applied to the liquid may not be fully transmitted to the cell suspension SL remaining in the tube T even though the plunger 201a has been pushed down to the bottom of the sample supply part 201. Therefore, a liquid residue of the cell suspension SL, that is, a dead volume DV, can occur in the tube T.

In contrast, the liquid delivery system 1 according to the present embodiment can control the occurrence of the dead volume by the cell suspension SL in the tube T being extruded due to the dead volume countermeasure liquid OL as described above.

Hereinbelow, examples of operations of the liquid delivery apparatus 70 according to the first embodiment will be described with reference to the figures similar to FIGS. 31 and 32 for the comparison with the liquid delivery apparatus 200 different from that of the embodiment illustrated in FIGS. 31 and 32.

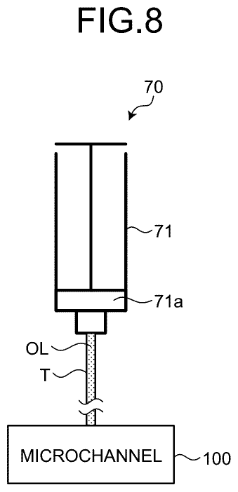

FIGS. 7 and 8 are diagrams illustrating the examples of the operations of the liquid delivery apparatus 70 according to the first embodiment. The liquid delivery apparatus 70 has the sample supply part 71 and the plunger 71a. Since the sample supply part 71 and the plunger 71a are as described above, the descriptions thereof will not be repeated. The sample supply part 71 is connected to the microchannel 100 via the tube T.

It is illustrated in FIG. 7 that the liquid delivery apparatus 70 is in the state prior to the delivery of the cell suspension SL into the microchannel 100. As illustrated in FIG. 7, in the liquid delivery apparatus 70 according to the present embodiment, the sample supply part 71 is pre-filled with the cell suspension SL and the dead volume countermeasure liquid OL.

Similar to the liquid delivery apparatus 200 in FIG. 31, for example, the liquid delivery drive source 81 (not illustrated) is driven to push the plunger 71a downwards, which enables the liquid delivery apparatus 70 to deliver the cell suspension SL into the microchannel 100. Since the dead volume countermeasure liquid OL has a lower specific gravity than that of the cell suspension SL, the internal liquid is extruded from the sample supply part 71 into the tube T in the order of the cell suspension SL, followed by the dead volume countermeasure liquid OL.

It is also illustrated in FIG. 8 that the plunger 71a has been pushed down to the bottom of the sample supply part 71. As illustrated in FIG. 8, when the plunger 71a has been pushed down to the bottom of the sample supply part 71, the dead volume countermeasure liquid OL is extruded into the tube T. Accordingly, the cell suspension SL remaining in the tube T is extruded into the microchannel 100. The amount of the cell suspension SL remaining in the tube T can be reduced as compared to the liquid delivery apparatus 200 that is provided without the dead volume countermeasure liquid OL.

Another method of controlling the dead volume is known as, for example, a technique to extrude residual liquid in a pipe with air. However, the conventional method of controlling the dead volume with air to extrude the residual liquid in the pipe does not ensure the stability of a flow rate. Therefore, in the liquid delivery method with air, the liquid may not be delivered at a stable flow rate when strict flow rate control is required when processes such as cell sorting and droplet formation are performed using the microchannel 100.

Hereinbelow, the results of a comparative evaluation on the stability of the flow rate between the liquid delivery method according to the first embodiment (hereinbelow, also referred to as a “proposed method”) and the method of controlling the dead volume with air (hereinbelow, also referred to as the “conventional method”) will be described.

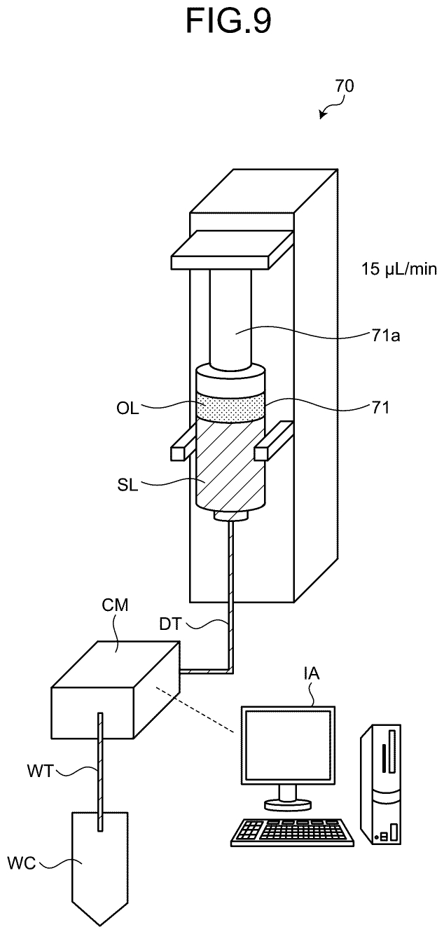

First, a configuration of the liquid delivery apparatus 70 for an evaluation of the proposed method will be described with reference to FIG. 9. FIG. 9 is an image diagram illustrating an example of an apparatus configuration in a comparative evaluation of the liquid delivery apparatus 70 according to the first embodiment.

As illustrated in FIG. 9, one end of a tube DT for the liquid delivery was coupled to the sample supply part 71 of the liquid delivery apparatus 70. The other end of the tube DT for the liquid delivery was coupled to the inlet of a flow meter CM. One end of a tube WT for the liquid waste was coupled to the outlet of the flow meter CM. The other end of the tube WT for the liquid waste was placed inside a liquid waste container WC so that the liquid waste from the flow meter CM flowed into the liquid waste container WC. The inside of the sample supply part 71 was pre-filled with the cell suspension SL and the dead volume countermeasure liquid OL.

The flow meter CM was configured to be connected to an information processing apparatus IA, and the information processing apparatus IA was configured to be able to acquire information on the measured flow rate.

A 2.5-ml syringe (manufactured by Terumo Corporation) was used as the sample supply part 71.

A silicone tube (0.5×2.5 mm) and a PTFE tube (with an inner diameter of 0.5 mm) were used as the tube DT for the liquid delivery. Specifically, a luer lock was coupled to the tip end of the 2.5-mL syringe, one end of the silicone tube was coupled to the luer lock, and the other end of the silicone tube was coupled to the PTFE tube.

A syringe pump (manufactured by Harvard Apparatus) was used as the liquid delivery drive source 81.

Flow EZ (manufactured by Fluigent) was used as the flow meter CM.

An RPMI-1640 medium was used as the cell suspension SL and canola oil was used as the dead volume countermeasure liquid OL. Specifically, the 2.5-ml syringe was first filled with 0.5 mL of the canola oil, followed by 1 mL of the RPMI-1640 medium. The 2.5-ml syringe was manually filled with the canola oil and RPMI-1640 medium using the same filling pipe.

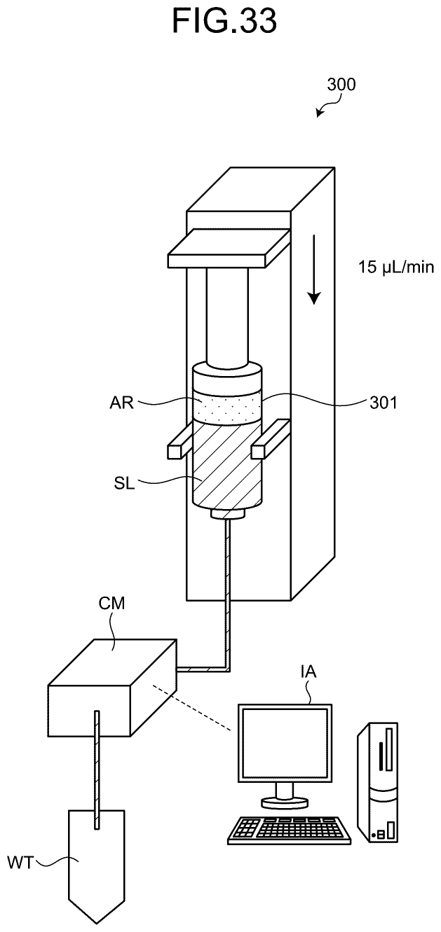

Next, a configuration of a liquid delivery apparatus 300 for an evaluation of the conventional method will be described with reference to FIG. 33. FIG. 33 is an image diagram illustrating an example of an apparatus configuration in a comparative evaluation of the liquid delivery apparatus 300 different from that of the embodiment.

The apparatus configuration in the comparative evaluation of the liquid delivery apparatus 300 is almost similar to that of the apparatus configuration in the comparative evaluation of the liquid delivery apparatus 70 according to the first embodiment illustrated in FIG. 9, and a sample supply part 301 was pre-filled with air AR instead of the dead volume countermeasure liquid OL. Specifically, the 2.5-ml syringe was first filled with 0.5 mL of the air AR, followed by 1 mL of the RPMI-1640 medium. The 2.5-ml syringe was manually filled with the air AR and RPMI-1640 medium using the same filling pipe.

Regarding the evaluation of the proposed and conventional methods, the 2.5-mL syringe was secured to the syringe pump so that the liquid delivery direction was substantially vertically oriented downwards; in this state, the syringe pump was operated with the setting of a delivery flow rate of 15 μL/min to start the liquid delivery from the syringe; and a flow rate monitoring was carried out for approximately 15 to 30 minutes. As a comparative example, a flow rate monitoring in a case in which only the RPMI-1640 medium was delivered in the same manner was also carried out.

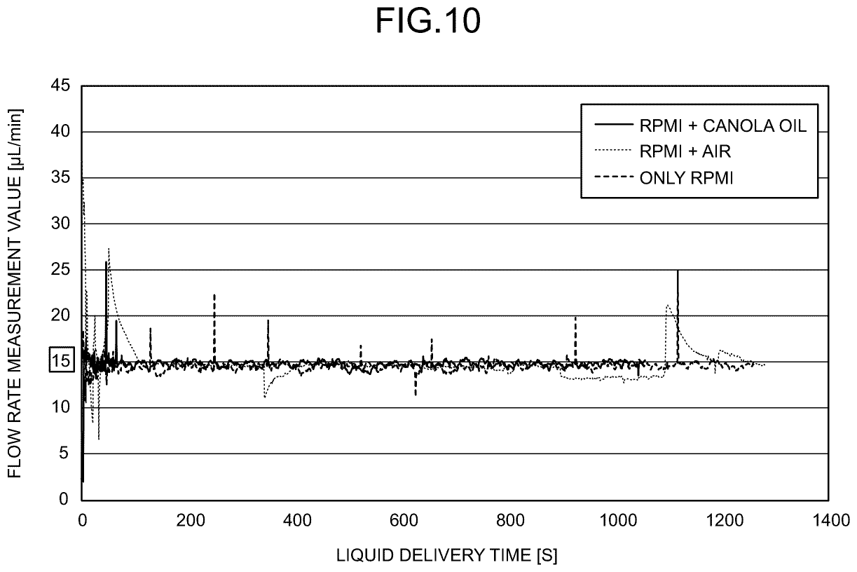

Next, the results of the comparative evaluation of the proposed and conventional methods will be described with reference to FIG. 10. FIG. 10 is a diagram illustrating an example of data of the comparative evaluation on the liquid delivery stability of the liquid delivery apparatus according to the first embodiment.

In FIG. 10, the horizontal axis indicates a liquid delivery time (S), which represents the time elapsed since the start of liquid delivery, and the vertical axis indicates a flow rate measurement value (μL/min), which is measured by the flow meter CM. The solid line in FIG. 10 indicates the transitions in the flow rate measurement values by the proposed method (the case in which the RPMI-1640 medium and canola oil were delivered), the dotted line indicates the transitions in the flow rate measurement values obtained by the conventional method (the case in which the RPMI-1640 medium and air were delivered), and the dashed line indicates the transitions in the flow rate measurement values obtained in the comparative example (the case in which only the RPMI-1640 medium was delivered).

It can be seen as illustrated in FIG. 10 that in the conventional method, peaks are present below 15 μL/min, which is the delivery flow rate set in the liquid delivery time around 350 to 400 seconds. It can also be seen that the flow rate measurement values are continuously below 15 μL/min even though the liquid delivery time is around 900 to 1100 seconds.

In contrast, with the proposed method, although upward peaks can be observed until the liquid delivery time is around 100 seconds, the flow rate measurement values are stably present at around 15 μL/min after 100 seconds.

With respect to the comparative example, it can be seen that some upward and downward peaks are present.

From the above comparative evaluation, it can be seen that the proposed method can continuously deliver liquid at the most stable flow rate. Therefore, it can be said that the proposed method significantly improves the liquid delivery stability as compared to the conventional method. In other words, according to the liquid delivery system 1 of the present embodiment, it is possible to deliver liquid continuously at a stable flow rate while controlling the occurrence of the dead volume.

### Second Embodiment

In the first embodiment described above, the configuration in which the cell suspension SL and the dead volume countermeasure liquid OL with which the sample supply part 71 is pre-filled are delivered has been described. A second embodiment describes a configuration in which the sample supply part 71 is pre-filled with the dead volume countermeasure liquid OL, followed by the cell suspension SL, so that the cell suspension SL is delivered into the microchannel 100. In the following descriptions of the second and subsequent embodiments, the same reference letters and numerals are given to the same components of the first embodiment, and the descriptions thereof may not be repeated.

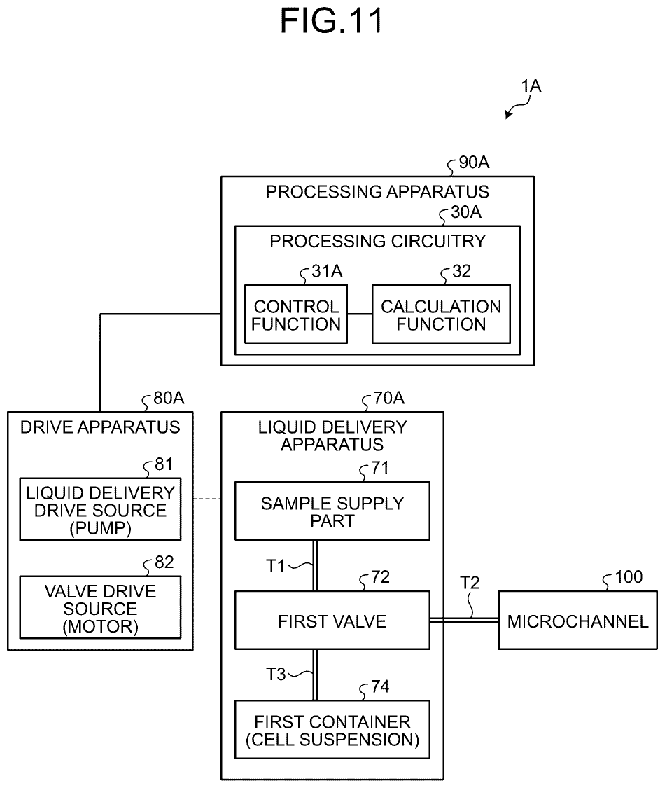

FIG. 11 is a block diagram illustrating an example of a configuration of a liquid delivery apparatus 70A and a drive apparatus 80A in a liquid delivery system 1A according to the second embodiment.

As illustrated in FIG. 11, the liquid delivery apparatus 70A has the sample supply part 71, a first valve 72, and a first container 74. The first valve 72 is an example of a first switching part. The drive apparatus 80A has the liquid delivery drive source 81 and a valve drive source 82. Processing circuitry 30A of a processing apparatus 90A has a control function 31A and the calculation function 32 as functional parts.

The sample supply part 71 is connected to the first valve 72 via a tube T1. The first valve 72 is connected to the microchannel 100 via a tube T2. The first valve 72 is connected to the first container 74 via a tube T3. Since the sample supply part 71, the liquid delivery drive source 81, and the calculation function 32 are the same as those of the first embodiment, the descriptions thereof are not repeated.

The first valve 72 switches between a state in which the sample supply part 71 can be filled with the cell suspension SL from the first container 74 described later and a state in which the cell suspension SL can be delivered from the sample supply part 71 to the microchannel 100.

The first valve 72 according to the present embodiment has the valve V1 and the valve V2 described below. For example, the first valve 72 allows the valve V1 to be closed and allows the valve V2 to open, so that the sample supply part 71 can be filled with the cell suspension SL from the first container 74. In addition, for example, the first valve 72 allows the valve V1 to open and allows the valve V2 to be closed, so that the cell suspension SL can be delivered from the sample supply part 71 to the microchannel 100.

The first valve 72 is driven by the valve drive source 82 described later to switch the valves V1 and V2 between the open and closed states.

The first container 74 is a container for storing therein the cell suspension SL. The drive of the liquid delivery drive source 81 causes the sample supply part 71 to be filled with the cell suspension SL in the first container 74.

The valve drive source 82 is a drive source which switches the first valve 72 state. For example, the valve drive source 82 switches the valve V1 and the valve V2 of the first valve 72 between the open state and the closed state. The valve drive source 82 is, for example, a motor. As an example, the valve drive source 82 is driven under the control of the control function 31 to switch the valve V1 and the valve V2 of the first valve 72 between the open state and the closed state.

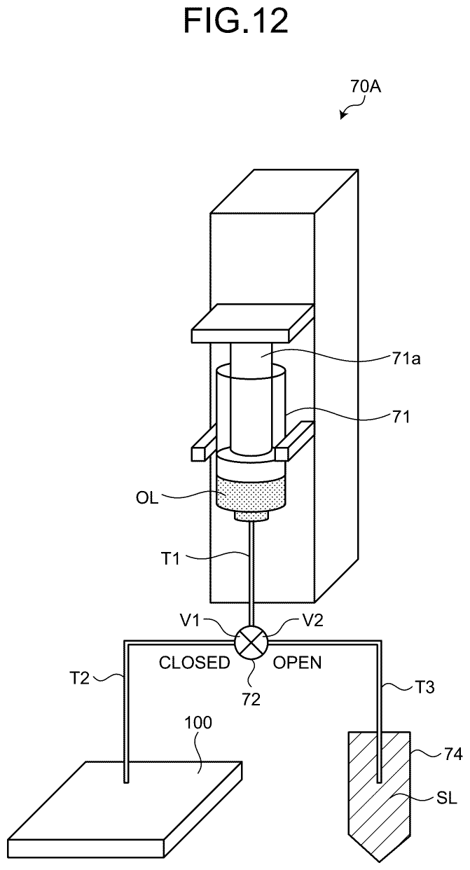

FIGS. 12 to 14 are herein perspective views illustrating examples of the appearance of the liquid delivery apparatus 70A according to the second embodiment. FIG. 12 illustrates an example of the liquid delivery apparatus 70A in the state prior to the sample supply part 71 being filled with the cell suspension SL.

As illustrated in FIG. 12, the sample supply part 71 has the plunger 71a. The sample supply part 71 is connected to the first valve 72 via the tube T1. The valve V1 of the first valve 72 is connected to the microchannel 100 via the tube T2. One end of the tube T3 is coupled to the valve V2 of the first valve 72. The other end of the tube T3 is immersed in the cell suspension SL in the first container 74.

In the first valve 72, the valve V1 is closed, and the valve V2 is open. In the present embodiment, the sample supply part 71 is pre-filled with only the dead volume countermeasure liquid OL.

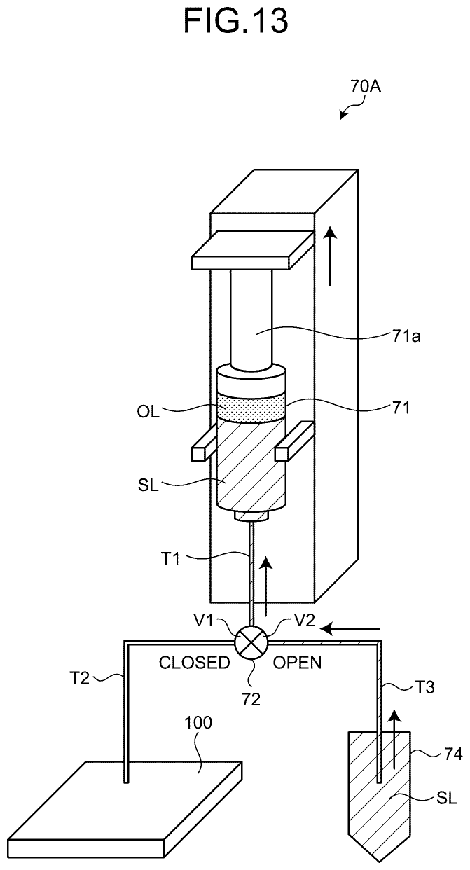

It is illustrated in FIG. 13 that the sample supply part 71 is in the state of being filled with the cell suspension SL. As illustrated in FIG. 13, when the plunger 71a is pulled up by the liquid delivery drive source 81 being driven in the state illustrated in FIG. 12, the cell suspension SL in the first container 74 is sucked through the tube T3 to be drawn into the tube T1. The sample supply part 71 is filled with the cell suspension SL in the tube T1 by the plunger 71a being further pulled up.

In this example, the volume of the cell suspension SL with which the sample supply part 71 is filled is input by the user through the input apparatus 50.

Here, it is assumed that the volume of the cell suspension SL with which the sample supply part 71 is filled is input by the user in advance through the input apparatus 50. The volume of the cell suspension SL with which the sample supply part 71 is filled represents the total volume of the cell suspension SL to be delivered into the microchannel 100.

As in the first embodiment, it is assumed that the set value of the delivery flow rate is input by the user in advance, and the volume of the dead volume countermeasure liquid OL with which the sample supply part 71 is filled is equal to or greater than the estimated dead volume calculated by the calculation function 32.

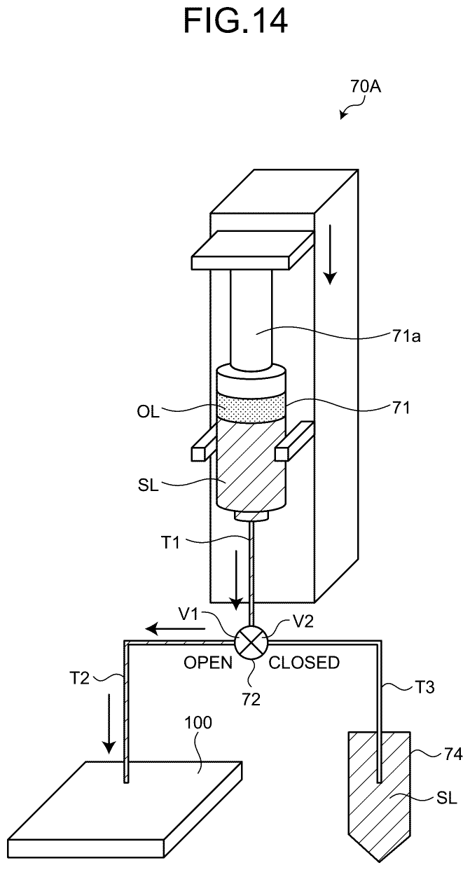

FIG. 14 illustrates an example of the liquid delivery apparatus 70A in the state of delivering the cell suspension SL into the microchannel 100. In a case in which the cell suspension SL is delivered into the microchannel 100, the control function 31A controls the valve drive source 82 to switch the valve V1 of the first valve 72 to be open and the valve V2 of the first valve 72 to be closed.

When the control function 31 drives the liquid delivery drive source 81, with the valve V1 of the first valve 72 open and the valve V2 of the first valve 72 closed, the plunger 71a moves downwards to extrude the cell suspension SL from the sample supply part 71 into the tube T1, as illustrated in FIG. 14. As the plunger 71a further moves downwards, the cell suspension SL in the tube T1 is delivered through the tube T2 into the microchannel 100.

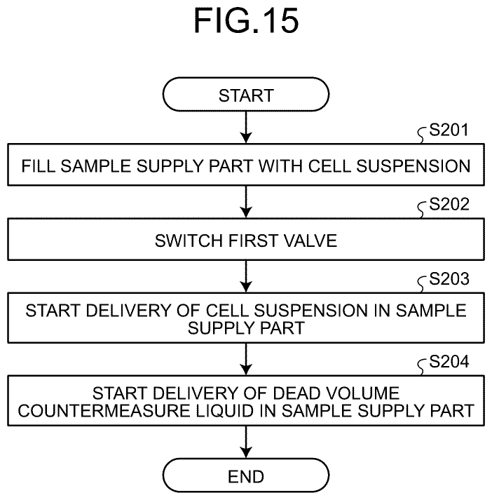

Next, processing executed by the liquid delivery system 1A according to the present embodiment will be described. FIG. 15 is a flowchart illustrating an example of processing executed by the liquid delivery system 1A according to the second embodiment.

As a precondition for this processing, it is assumed that the calculation function 32 has already calculated the estimated dead volumes of the tubes T1 and T2. It is assumed that the control function 31 has already set a delivery volume of the dead volume countermeasure liquid OL based on the estimated dead volumes of the tubes T1 and T2, which have been calculated. It is also assumed that the sample supply part 71 that has already filled with the dead volume countermeasure liquid OL is installed on the liquid delivery apparatus 70A. It is further assumed that the volume and delivery flow rate of the cell suspension SL with which the sample supply part 71 is filled are set in advance. It is further assumed that the valve V1 of the first valve 72 is closed, and the valve V2 of the first valve 72 is open.

First, the control function 31A controls the liquid delivery drive source 81 of the drive apparatus 80A to allow the sample supply part 71 to be filled with the cell suspension SL equivalent to the set filling volume (step S201).

For example, the control function 31A controls the liquid delivery drive source 81 to cause the plunger 71a to be pulled up, thereby starting the suction of the cell suspension SL in the first container 74 to be drawn into the tube T3. The control function 31A causes the plunger 71a to be further pulled up according to the set filling volume of the cell suspension SL. The sample supply part 71 is accordingly filled with the cell suspension SL in the tube T3 through the tube T1.

After the sample supply part 71 is filled with the set volume of the cell suspension SL, the control function 31A controls the valve drive source 82 of the drive apparatus 80A to switch the valve V1 of the first valve 72 to be open and the valve V2 of the first valve 72 to be closed (step S202).

Next, the control function 31A controls the liquid delivery drive source 81 of the drive apparatus 80A to start the delivery of the cell suspension SL (step S203).

For example, the control function 31A controls the liquid delivery drive source 81 to press the plunger 71a downwards and extrude the cell suspension SL in the sample supply part 71 into the tube T1 to achieve a predetermined flow rate. The control function 31A causes the plunger 71a to be further pressed downwards. The cell suspension SL in the tube T1 is accordingly delivered through the tube T2 into the microchannel 100.

Next, the control function 31A starts the delivery of the dead volume countermeasure liquid OL in the sample supply part 71 (step S204) and completes this process.

For example, after the total volume of the cell suspension SL in the sample supply part 71 is extruded into the tube T1 according to the calculation, the control function 31 causes the dead volume countermeasure liquid OL in the sample supply part 71, equivalent to the estimated dead volumes of the tubes T1 and T2 calculated by the calculation function 32, to be extruded into the tube T1.

The approximate total volume of the cell suspension SL with which the sample supply part 71 is filled can be accordingly delivered into the microchannel 100.

According to the liquid delivery system 1A of the second embodiment described above, it is possible to fill the cell suspension SL automatically. Thus, for example, it is possible to prevent a situation in which the dead volume countermeasure liquid OL is extruded into the tube T at a timing earlier than the calculated timing, resulting in the dead volume countermeasure liquid OL entering into the microchannel 100, which is caused due to the fact that the actual filling volume is less than the input value of the filling volume in a case in which the user manually fills the sample supply part 71 with the cell suspension SL and manually inputs the filling volume.

According to the liquid delivery system 1A of the second embodiment, it is also possible to deliver liquid continuously at a stable flow rate while controlling the occurrence of the dead volume, similarly to the liquid delivery system 1 according to the first embodiment.

### Third Embodiment

The second embodiment has described the configuration in which the sample supply part 71 is filled with the dead volume countermeasure liquid OL, followed by the cell suspension SL, so that the cell suspension SL is delivered into the microchannel 100. A third embodiment describes a configuration in which the empty sample supply part 71 is filled with the cell suspension SL and the dead volume countermeasure liquid OL to deliver the cell suspension SL into the microchannel 100.

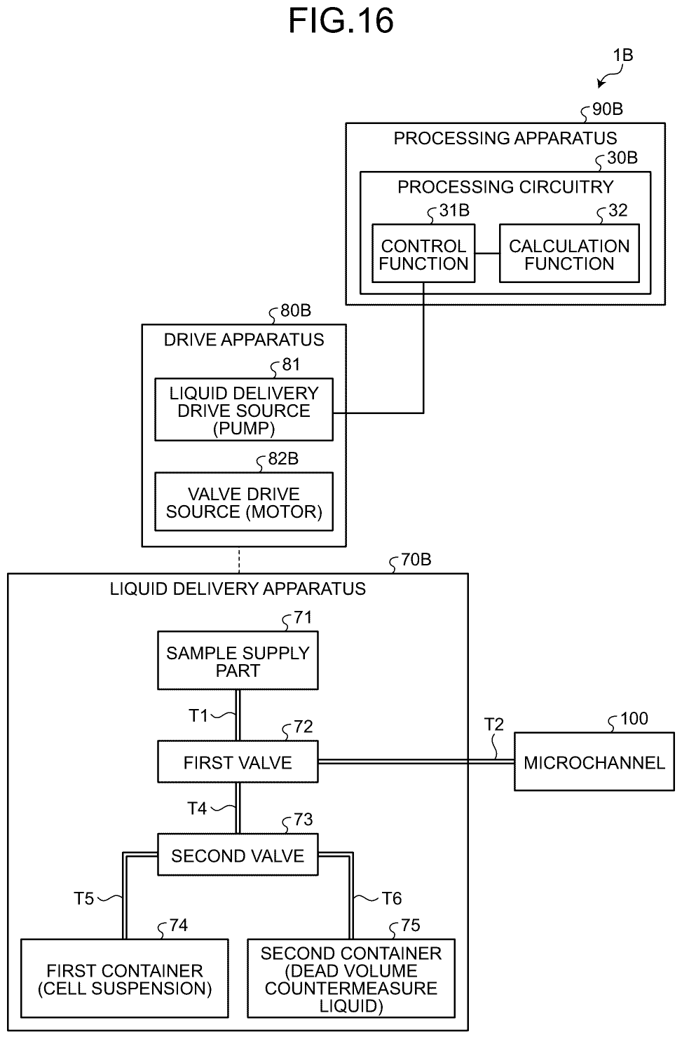

FIG. 16 is a block diagram illustrating an example of a configuration of a liquid delivery apparatus 70B and a drive apparatus 80B in a liquid delivery system 1B according to the third embodiment.

As illustrated in FIG. 16, the liquid delivery apparatus 70B has the sample supply part 71, the first valve 72, a second valve 73, the first container 74, and a second container 75. The second valve 73 is an example of a second switching part. The drive apparatus 80B has the liquid delivery drive source 81 and a valve drive source 82B. Processing circuitry 30B of a processing apparatus 90B has a control function 31B and the calculation function 32 as functional parts.

The sample supply part 71 is connected to the first valve 72 via the tube T1. The first valve 72 is connected to the microchannel 100 via the tube T2. The first valve 72 is connected to the second valve 73 via a tube T4. The second valve 73 is connected to the first container 74 via a tube T5. The second valve 73 is connected to the second container 75 via a tube T6.

Since the sample supply part 71, the first valve 72, the first container 74, the liquid delivery drive source 81, and the calculation function 32 are the same as those of the first embodiment and the second embodiment, the descriptions thereof are not repeated.

The second valve 73 switches between a state in which the sample supply part 71 can be filled with the dead volume countermeasure liquid OL from the second container 75 described later and a state in which the sample supply part 71 can be filled with the cell suspension SL from the first container 74.

The second valve 73 according to the present embodiment has a valve V3 and a valve V4 described below. For example, the second valve 73 allows the valve V3 to be closed and allows the valve V4 to be open, so that the sample supply part 71 can be filled with the dead volume countermeasure liquid OL from the second container 75. In addition, for example, the second valve 73 allows the valve V3 to be open and allows the valve V4 to be closed, so that the sample supply part 71 can be filled with the cell suspension SL from the first container 74.

The second valve 73 is driven by the valve drive source 82B to switch the valves V3 and V4 between the open and closed states.

The second container 75 is a container for storing therein the dead volume countermeasure liquid OL. The drive of the liquid delivery drive source 81 causes the sample supply part 71 to be filled with the dead volume countermeasure liquid OL in the second container 75.

The valve drive source 82B switches the states of the first valve 72 and the second valve 73. For example, the valve drive source 82B is driven under the control of the control function 31B to switch the valve V1 and the valve V2 of the first valve 72, as well as the valve V3 and the valve V4 of the second valve 73 between the open state and the closed state.

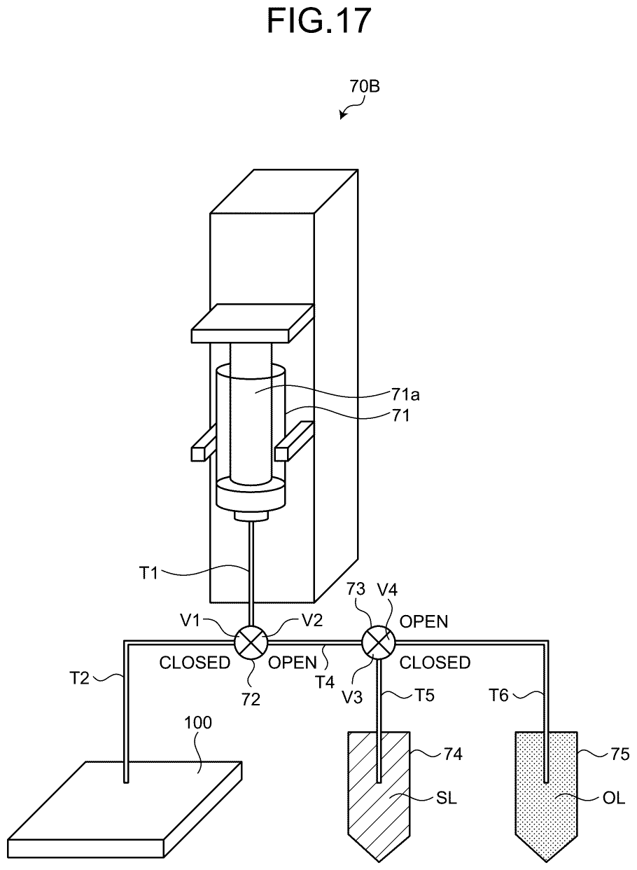

FIGS. 17 to 20 are herein perspective views illustrating examples of the appearance of the liquid delivery apparatus 70B according to the third embodiment. FIG. 17 illustrates an example of the liquid delivery apparatus 70B in the state prior to the sample supply part 71 being filled with the dead volume countermeasure liquid OL.

As illustrated in FIG. 17, the sample supply part 71 has the plunger 71a. The sample supply part 71 is connected to the first valve 72 via the tube T1. The valve V1 of the first valve 72 is connected to the microchannel 100 via the tube T2.

The valve V2 of the first valve 72 is connected to the second valve 73 via the tube T4. One end of the tube T5 is coupled to the valve V3 of the second valve 73. The other end of the tube T5 is immersed in the cell suspension SL in the first container 74. One end of the tube T6 is coupled to the valve V4 of the second valve 73. The other end of the tube T6 is immersed in the dead volume countermeasure liquid OL in the second container 75.

In the first valve 72, the valve V1 is closed, and the valve V2 is open. In the second valve 73, the valve V3 is closed, and the valve V4 is open. In the present embodiment, the sample supply part 71 is empty before the filling operation of the dead volume countermeasure liquid OL is performed.

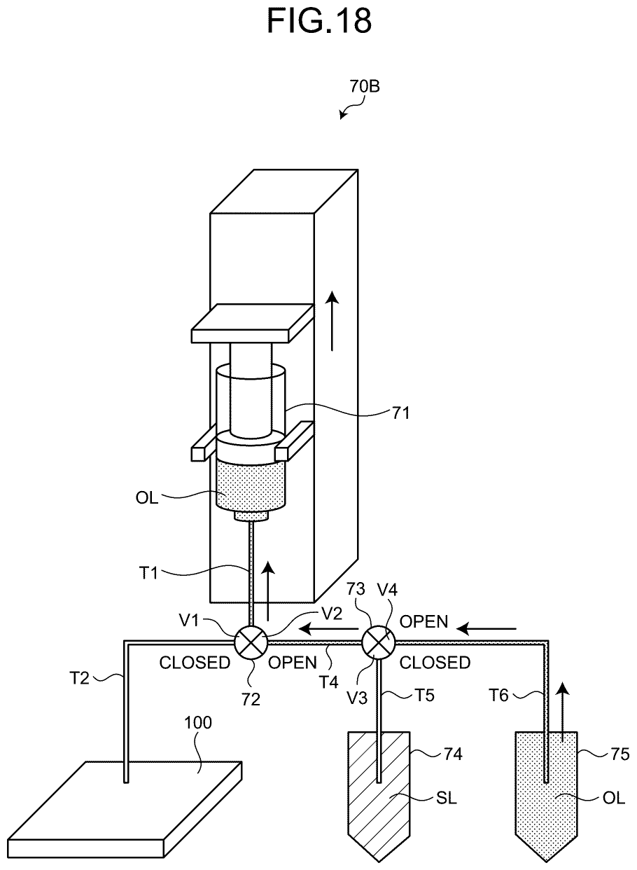

It is illustrated in FIG. 18 that the sample supply part 71 is in the state of being filled with the dead volume countermeasure liquid OL. As illustrated in FIG. 18, when the plunger 71a is pulled up by the liquid delivery drive source 81 being driven in the state illustrated in FIG. 17, the dead volume countermeasure liquid OL in the second container 75 is sucked through the tube T6 and the tube T4 to be drawn into the tube T1. The sample supply part 71 is filled with the dead volume countermeasure liquid OL in the tube T1 by the plunger 71a being further pulled up.

Here, the volume of the dead volume countermeasure liquid OL with which the sample supply part 71 is filled is determined based on the estimated dead volume in the tube T, which is calculated by the calculation function 32. For example, a volume of the estimated dead volume with a predetermined value added is employed as the volume of the dead volume countermeasure liquid OL with which the sample supply part 71 is filled. Accordingly, it is possible to prevent a situation in which the dead volume countermeasure liquid OL to be extruded into the tube T is insufficient, resulting in no elimination of the dead volume in the tube T.

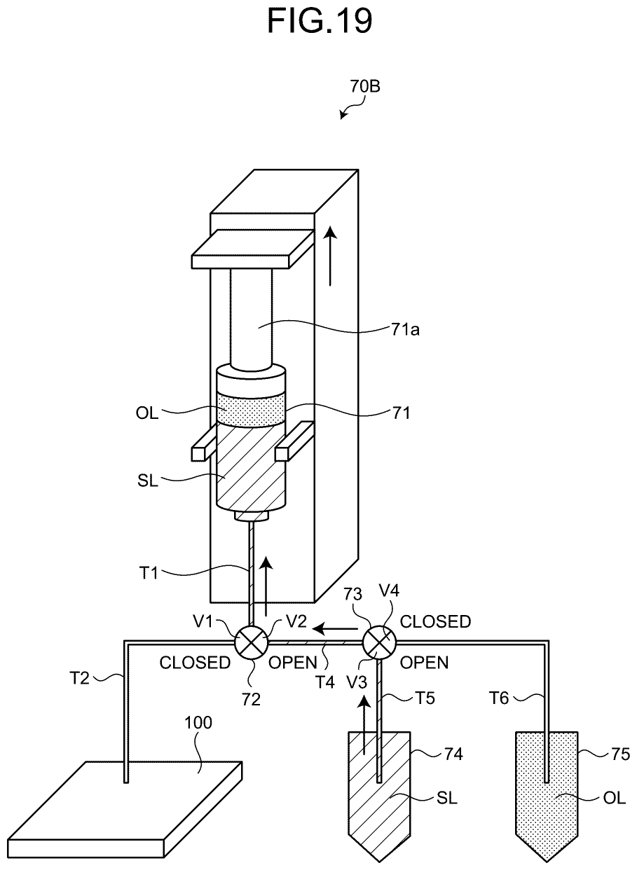

It is illustrated in FIG. 19 that the sample supply part 71 is in the state of being filled with the cell suspension SL. In a case in which the sample supply part 71 is filled with the cell suspension SL, the control function 31B controls the valve drive source 82B to switch the valve V3 of the second valve 73 to be open and the valve V4 of the second valve 73 to be closed.

When the plunger 71a is pulled up by the liquid delivery drive source 81 being driven, in this state, the cell suspension SL in the first container 74 is sucked through the tube T5 and the tube T4 to be drawn into the tube T1. The sample supply part 71 is filled with the cell suspension SL in the tube T1 by the plunger 71a being further pulled up.

Here, similarly to the second embodiment, it is assumed that set values of the volume and delivery flow rate of the cell suspension SL with which the sample supply part 71 is filled are input by the user in advance.

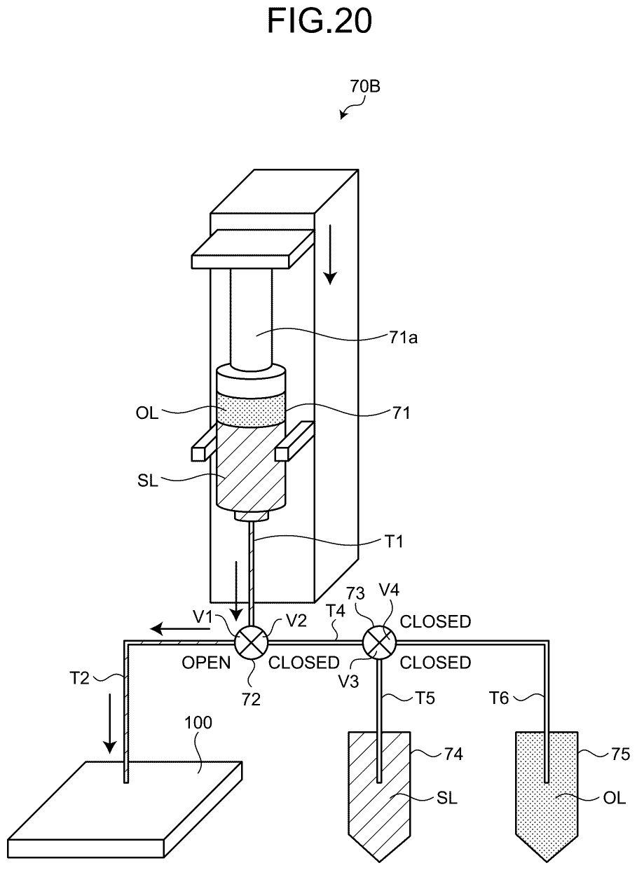

FIG. 20 illustrates an example of the liquid delivery apparatus 70B in the state of delivering the cell suspension SL into the microchannel 100. In a case in which the cell suspension SL is delivered into the microchannel 100, the control function 31B controls the valve drive source 82B to switch the valve V1 of the first valve 72 to be open and the valve V2 of the first valve 72 to be closed.

When the control function 31 drives the liquid delivery drive source 81, with the valve V1 of the first valve 72 opened and the valve V2 of the first valve 72 closed, the plunger 71a moves downwards to extrude the cell suspension SL from the sample supply part 71 into the tube T1, as illustrated in FIG. 20. As the plunger 71a further moves downwards, the cell suspension SL in the tube T1 is delivered through the tube T2 into the microchannel 100.

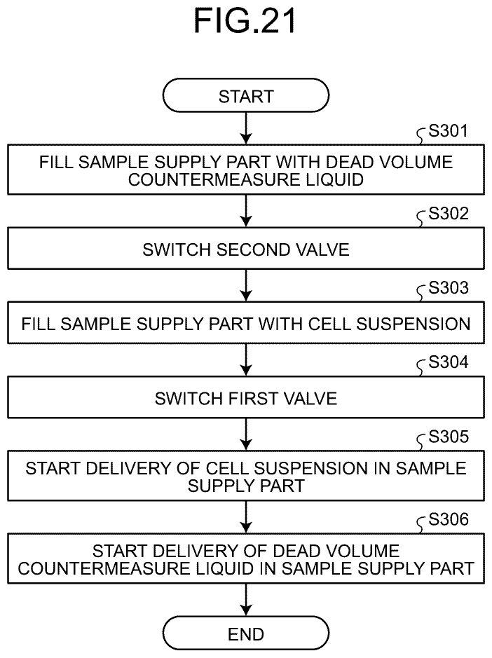

Next, processing executed by the liquid delivery system 1B according to the present embodiment will be described. FIG. 21 is a flowchart illustrating an example of processing executed by the liquid delivery system 1B according to the third embodiment.

As a precondition for this processing, it is assumed that the calculation function 32 has already calculated the estimated dead volumes of the tubes T1 and T2. It is assumed that the control function 31 has already set a volume of the dead volume countermeasure liquid OL with which the sample supply part 71 is filled and a volume thereof to be delivered into the tube T1 based on the estimated dead volumes of the tubes T1 and T2, which have been calculated. It is further assumed that the volume and delivery flow rate of the cell suspension SL with which the sample supply part 71 is filled are set in advance. It is further assumed that the valve V1 of the first valve 72 is closed, and the valve V2 of the first valve 72 is open. It is further assumed that the valve V3 of the second valve 73 is closed, and the valve V4 of the second valve 73 is open.

First, the control function 31B controls the liquid delivery drive source 81 of the drive apparatus 80B to allow the sample supply part 71 to be filled with the dead volume countermeasure liquid OL equivalent to the set filling volume (step S301).

For example, the control function 31B controls the liquid delivery drive source 81 to cause the plunger 71a to be pulled up, thereby performing the suction of the dead volume countermeasure liquid OL in the second container 75 to be drawn into the tube T6. The control function 31B causes the plunger 71a to be further pulled up according to the set filling volume of the dead volume countermeasure liquid OL. The sample supply part 71 is accordingly filled with the dead volume countermeasure liquid OL in the tube T6 through the tube T4 and the tube T1.

After the sample supply part 71 is filled with the volume of the dead volume countermeasure liquid OL, which is determined based on the estimated dead volume, the control function 31B controls the valve drive source 82B of the drive apparatus 80B to switch the valve V3 of the second valve 73 to be open and the valve V4 of the second valve 73 to be closed (step S302).

First, the control function 31B controls the liquid delivery drive source 81 of the drive apparatus 80B to allow the sample supply part 71 to be filled with the cell suspension SL equivalent to the set filling volume (step S303).

For example, the control function 31B controls the liquid delivery drive source 81 to cause the plunger 71a to be pulled up, thereby performing the suction of the cell suspension SL in the first container 74 to be drawn into the tube T5. The control function 31B causes the plunger 71a to be further pulled up according to the set filling volume of the cell suspension SL. The sample supply part 71 is accordingly filled with the cell suspension SL in the tube T5 through the tube T4 and the tube T1.

After the sample supply part 71 is filled with the set volume of the cell suspension SL, the control function 31B controls the valve drive source 82B of the drive apparatus 80B to switch the valve V1 of the first valve 72 to be open and the valve V2 of the first valve 72 to be closed (step S304).

Since steps S305 and S306 are the same as steps S203 and S204 in FIG. 15, the descriptions are not repeated. The approximate total volume of the cell suspension SL with which the sample supply part 71 is filled can be accordingly delivered into the microchannel 100.

According to the liquid delivery system 1B of the third embodiment described above, it is possible to fill the dead volume countermeasure liquid OL automatically. Thus, for example, it is possible to prevent a situation in which in the processing of extruding the dead volume countermeasure liquid OL into the tube T, air is extruded into the tube T1 instead of the dead volume countermeasure liquid OL, resulting in impairing the stability of delivering liquid, which is caused due to the fact that the filling volume of the dead volume countermeasure liquid OL is less than the estimated dead volumes in the tubes T1 and T2 in a case in which the user manually fills the sample supply part 71 with the dead volume countermeasure liquid OL.

According to the liquid delivery system 1B of the third embodiment, it is also possible to deliver liquid continuously at a stable flow rate while controlling the occurrence of the dead volume, similarly to the liquid delivery system 1 according to the first embodiment and the second embodiment.

The above-described embodiments can also be implemented with appropriate modifications by changing a part of the configuration or function included in each apparatus. Therefore, some of modifications according to the above-described embodiments will be described below as other embodiments. In the following, the points that differ from the above-described embodiments will be mainly described, and the detailed descriptions of the points in common with those already described will not be repeated. In addition, some of the modifications described below may be implemented individually or implemented in combination as appropriate.

### First Modification

In the first to third embodiments described above, the configuration in which the calculation function 32 calculates the estimated dead volume in the tube T has been described. However, the calculation function 32 may further calculate an estimated dead volume of channels in the microchannel 100.

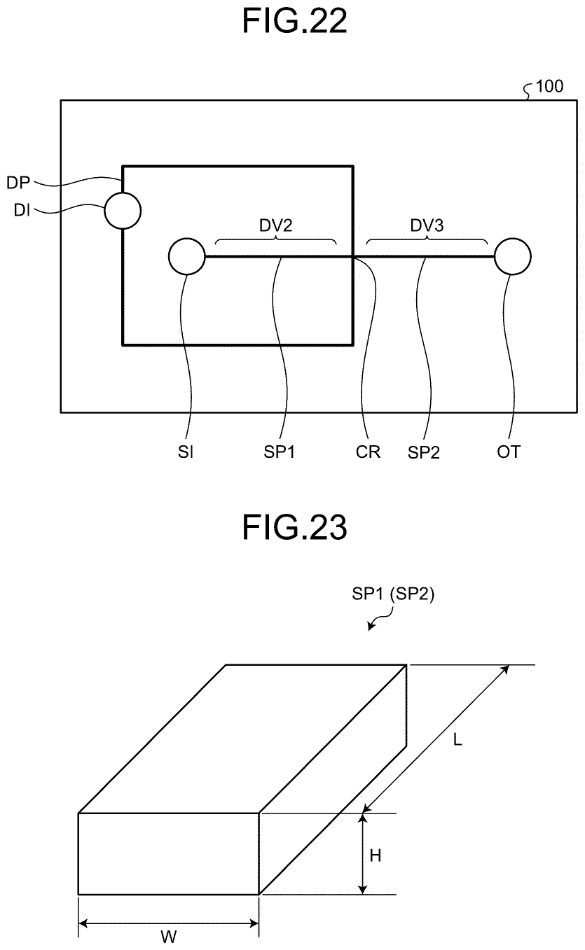

FIG. 22 is herein a schematic diagram illustrating an example of a configuration of the microchannel 100 according to a first modification. The microchannel 100 in FIG. 22 is an example of the microchannel 100 used for the droplet formation.

The microchannel 100 according to the present modification has an oil inlet DI, an oil channel DP, a sample inlet SI, a first sample channel SP1, a droplet formation region CR, a second sample channel SP2, and a collection port OT.

The oil inlet DI is an inlet into which an oil for droplet formation is injected. The oil channel DP is a channel for delivering the oil for droplet formation injected from the oil inlet DI to the droplet formation region CR.

The sample inlet SI is an inlet into which the cell suspension SL is injected. The sample inlet SI is coupled to, for example, one end of the tube T, the other end of the tube T being coupled to the tip end of the sample supply part 71. The sample channel SP1 is a channel for delivering the cell suspension SL injected from the sample inlet SI to the droplet formation region CR.

The droplet formation region CR is a region for forming droplets. For example, in the droplet formation region CR, the droplet generating oil shears the cell suspension SL to form a droplet in which the cells in the cell suspension SL are encapsulated. The second sample channel SP2 is a channel for delivering droplets formed in the droplet formation region CR to the collection port OT. The collection port OT is a collection port for collecting the formed droplets.

In an example in FIG. 22, the dead volume can occur because the cell suspension SL in the first sample channel SP1 may not be extruded out completely. Similarly, the dead volume can occur in the second sample channel SP2 because droplets may adhere to walls of the channels to remain.

Therefore, the calculation function 32 of the processing circuitry 30 may calculate an estimated dead volume in the channels of the microchannel 100 in addition to an estimated dead volume in the pipe. For example, the calculation function 32 may calculate an estimated dead volume DV2 of the first sample channel SP1 and an estimated dead volume DV3 of the second sample channel SP2, in addition to the estimated dead volume DV1 in the tube T. Hereinbelow, processing of calculating the estimated dead volume in the microchannel 100 will be described with reference to FIG. 23.

FIG. 23 is a diagram illustrating an example of the processing of calculating the estimated dead volume in the microchannel. The estimated dead volume in the microchannel is calculated by an estimation equation expressed with a channel cross-sectional area×a channel length.

In the example in FIG. 23, in a case in which the channel width is denoted by W, the channel depth is denoted by H, and the channel length is denoted by L1, the estimated dead volume DV2 in the first sample channel SP1 in FIG. 22 can be obtained by the calculation of the equation DV2=W×H×L1. In this case, the channel width, channel depth, and channel length are examples of information of the microchannel. The estimated dead volume DV3 of the second sample channel SP2 can also be calculated by the same equation.

The control function 31 described above causes the cell suspension SL and the dead volume countermeasure liquid OL to be delivered into the microchannel 100 based on the estimated dead volume calculated by the calculation function 32. For example, the control function 31 executes processing of employing an estimated dead volume of the pipe and microchannel obtained by adding the estimated dead volume DV1, the estimated dead volume DV2, and the estimated dead volume DV3 and eliminating the dead volume by using the dead volume countermeasure liquid OL with a volume equivalent to the estimated dead volume of the pipe and microchannel.

In the example in FIG. 22, regarding the droplets remaining in the second sample channel SP2, it may be possible to eliminate the dead volume with a liquid other than the dead volume countermeasure liquid OL. In such a case, the control function 31 may execute processing to eliminate the dead volume by using the dead volume countermeasure liquid OL with a volume equivalent to a value excluding the estimated dead volume DV3.

The user may also be able to select which portions are to be the dead volume. Accordingly, the control function 31 can execute liquid delivery processing according to the user's wishes, such as using only the estimated dead volume DV1 as the estimated dead volume, for example, in a case in which the user wants to prevent the dead volume countermeasure liquid OL from entering the microchannel 100 as much as possible.

### Second Modification

In the first and third embodiments described above, the configuration in which the liquid delivery direction from the sample supply part 71 to the microchannel 100 is oriented downwards was described. However, the liquid delivery direction is not limited thereto. For example, the liquid delivery direction from the sample supply part 71 to the microchannel 100 may be oriented upwards.

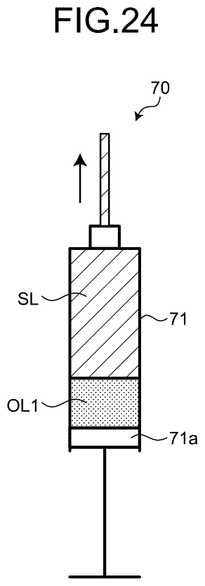

FIG. 24 is a diagram illustrating an example of an operation of the liquid delivery apparatus 70 according to a second modification. As illustrated in FIG. 24, the liquid delivery apparatus 70 according to the present modification has the sample supply part 71 and the plunger 71a. In the present modification, the sample supply part 71 is secured so that the liquid delivery direction is oriented upwards. For example, the sample supply part 71 is secured to the liquid delivery drive source 81 (not illustrated in FIG. 24) to be substantially vertically oriented upwards.

In FIG. 24, the liquid delivery direction is exemplified to be substantially vertically oriented upwards, but the liquid delivery direction is not limited to the substantially vertically upward direction. In the present modification, the liquid delivery direction may be any direction if among vector components in the liquid delivery direction, the vector component in the anti-gravity direction is greater than the vector components in the directions other than the anti-gravity direction. For example, the liquid delivery direction may be diagonally upward or other directions, if among the vector components in the liquid delivery direction, the vector component in the anti-gravity direction is greater than the vector components in the directions other than the anti-gravity direction.

Since the plunger 71a is the same as that described in the embodiments, the description thereof will not be repeated. The sample supply part 71 is connected to the microchannel 100 (not illustrated in FIG. 24), which is positioned above the sample supply part 71, via the tube T.

Similar to the first embodiment, a liquid with a specific gravity that depends on the liquid delivery direction is used as the dead volume countermeasure liquid OL1. In a case in which the liquid delivery direction is upward, a dead volume countermeasure liquid OL1 is a liquid with a higher specific gravity than that of the cell suspension SL. Examples of the liquid with a higher specific gravity than that of the cell suspension SL include hydro fluoro ether (HFE)-7500.

Since the dead volume countermeasure liquid OL1 with a higher specific gravity than that of the cell suspension SL is used, the dead volume countermeasure liquid OL1 with a high specific gravity is placed on the lower side of the sample supply part 71, and the cell suspension SL with a low specific gravity is placed on the upper side, as illustrated in FIG. 24.

It is illustrated in FIG. 24 that the cell suspension SL with which the sample supply part 71 is pre-filled is in the state prior to the delivery into the microchannel 100. For example, the liquid delivery drive source (not illustrated) such as a pump is driven to push the plunger 71a upwards to extrude the cell suspension SL into the tube T. By the plunger 71a being pushed up, the delivery of the cell suspension SL into the microchannel 100 can be achieved.

The plunger 71a can be pushed up to extrude the dead volume countermeasure liquid OL1 into the tube T, thereby controlling the dead volume of the sample supply part 71 in the same manner as in the above-described embodiments.

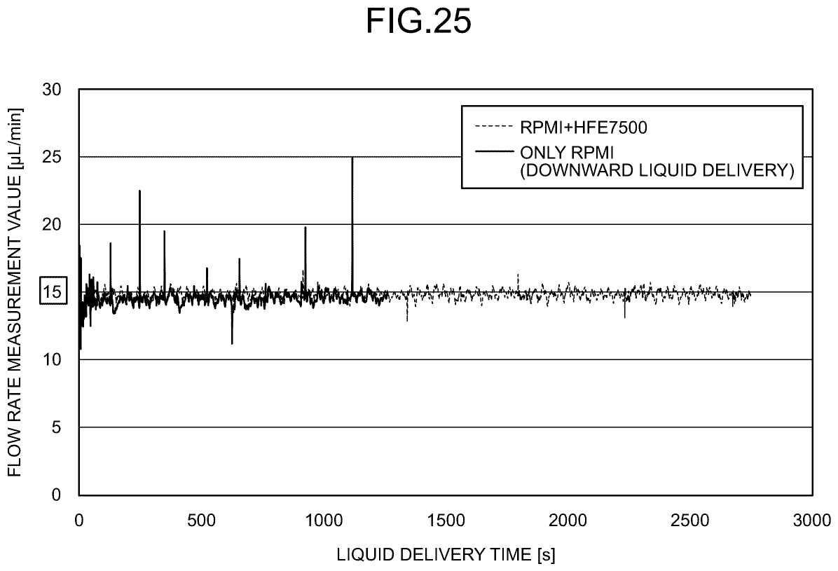

FIG. 25 is a diagram illustrating an example of data of the comparative evaluation on the liquid delivery stability of the liquid delivery apparatus according to the second modification. Here, FIG. 25 illustrates the results of a comparative evaluation on the flow rate stability of a method of the present modification and the flow rate stability of the conventional method. In the method of the present modification, the flow rate measurement was carried out with the 2.5-mL syringe secured vertically upwards to the syringe pump by using the same apparatus configuration as that illustrated in FIG. 9. HFE-7500 was used as the dead volume countermeasure liquid OL1.

In FIG. 25, similarly to FIG. 10, the horizontal axis indicates a liquid delivery time (S), which represents the time elapsed since the start of liquid delivery, and the vertical axis indicates a flow rate measurement value (μL/min), which is measured by the flow meter CM. The dashed line in the graph in FIG. 25 indicates the transitions in the flow rate measurement values by the method of the modification (the case in which the RPMI-1640 medium and HFE-7500 were delivered), and the solid line indicates the transitions in the flow rate measurement values obtained in the comparative example (the case in which only the RPMI-1640 medium was delivered downwards).

As illustrated in FIG. 25, it can be seen that the flow rate measurement values are stable at around 15 μL/min from the start of liquid delivery in the method of the modification. It can also be seen that the liquid is able to be delivered at a stable flow rate as compared to the comparative example. Therefore, it can be said that the liquid delivery system 1 according to the present modification can also achieve the continuous delivery at a stable flow rate, similarly to the first embodiment described above.

In addition, the dead volume can be controlled while continuously delivering the liquid at a stable flow rate even though liquid delivery is performed upwards, which enables an increase in the degree of freedom in the configuration of the liquid delivery apparatus 70. For example, it is possible to provide the liquid delivery apparatus 70 capable of controlling the dead volume and continuously delivering the liquid at a stable flow rate even in a situation in which the microchannel 100 is necessarily installed over the upper side of the sample supply part 71 due to the environment in which the apparatus is installed.

### Third Modification

In the first to third embodiments described above, the configuration in which the cell suspension SL and the dead volume countermeasure liquid OL in the sample supply part 71 are extruded by the plunger 71a and delivered into the microchannel 100 has been described. However, the liquid delivery system 1 may control the pressure from a pressure supply source such as a pump to deliver liquid into the microchannel 100.

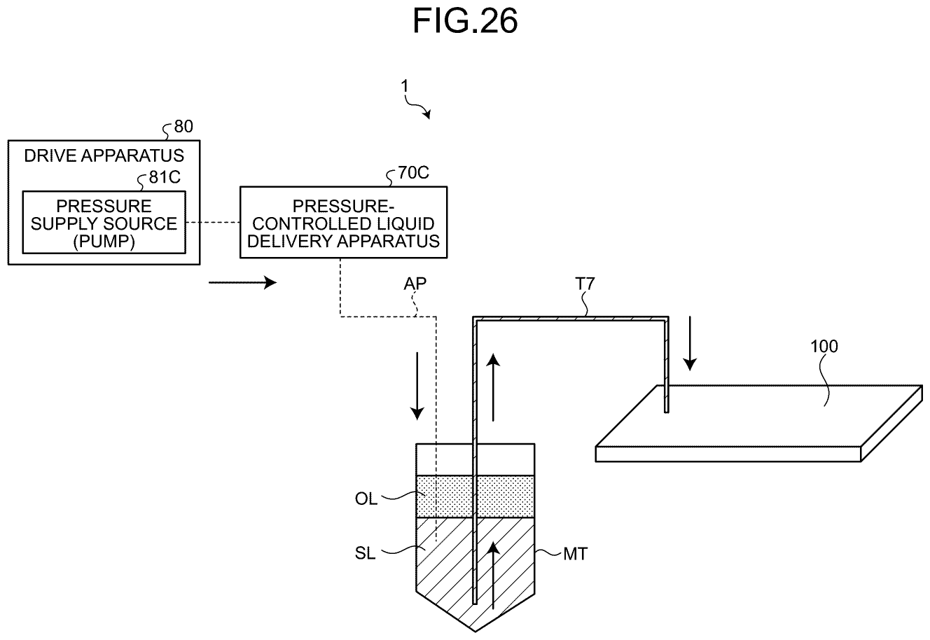

FIG. 26 is a block diagram illustrating an example of a configuration of the liquid delivery system 1 according to a third modification. As illustrated in FIG. 26, the liquid delivery system 1 according to the present modification has the drive apparatus 80, a pressure-controlled liquid delivery apparatus 70C, a microtube MT, and the microchannel 100. One end of the tube T7 is coupled to the microchannel 100, and the other end of the tube T7 is immersed in a layer of the cell suspension SL in the microtube MT.

The drive apparatus 80 is provided with a pressure supply source 81C. The pressure supply source 81C provides the pressure to the pressure-controlled liquid delivery apparatus 70C. The pressure supply source 81C is, for example, a pump.

The pressure-controlled liquid delivery apparatus 70C controls the pressure supplied by the pressure supply source 81C to generate air pressure AP and deliver the air pressure AP into the microtube MT. The pressure-controlled liquid delivery apparatus 70C can control the pressure supplied from the pressure supply source 81C to deliver the cell suspension SL into the microchannel 100 at a predetermined flow rate.

The microtube MT stores therein the cell suspension SL and the dead volume countermeasure liquid OL. The dead volume countermeasure liquid OL of the present modification is a liquid with a lower specific gravity than that of the cell suspension SL, similarly to the first embodiment. In the present modification, the microtube MT is pre-filled with the cell suspension SL and the dead volume countermeasure liquid OL. The filling with the cell suspension SL and the dead volume countermeasure liquid OL may be manually performed by the user using a pipette or the like, or may be automatically performed using an automatic dispensing machine or the like.

Here, the air pressure delivered from the pressure-controlled liquid delivery apparatus 70C into the microtube MT causes the cell suspension SL in the microtube MT to be delivered into the tube T7. The pressure-controlled liquid delivery apparatus 70C continues to deliver the air pressure into the microtubes MT, which causes the cell suspension SL to be delivered through the tube T7 into the microchannel 100. The liquid delivery system 1 of the present modification can accordingly deliver the cell suspension SL into the microchannel 100.

In the present modification, since the cell suspension SL with a high specific gravity is first delivered into the tube T7, the cell suspension SL and the dead volume countermeasure liquid OL are delivered into the tube T7 in this order. Therefore, as in the first embodiment described above, the cell suspension SL remaining in the tube T7 can be extruded by the dead volume countermeasure liquid OL to control the dead volume in the tube T7.

### Fourth Modification

In the third embodiment, the configuration in which the switching between the processing of filling the sample supply part 71 with the dead volume countermeasure liquid OL and the processing of filling the sample supply part 71 with the cell suspension solution SL is performed by switching the second valve 73. However, the switching between the processing of filling the sample supply part 71 with the dead volume countermeasure liquid OL and the processing of filling the sample supply part 71 with the cell suspension solution SL may be performed by the tube displacement.

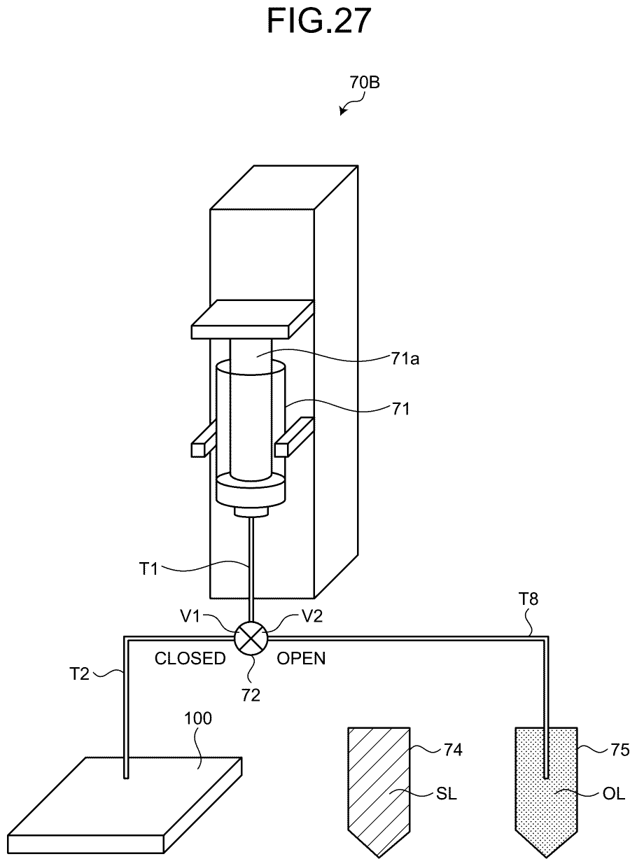

Here, FIGS. 27 to 30 are perspective views illustrating examples of the appearance of the liquid delivery apparatus 70B according to a fourth modification. FIG. 27 illustrates an example of the liquid delivery apparatus 70B in the state prior to the sample supply part 71 being filled with the dead volume countermeasure liquid OL.

As illustrated in FIG. 27, the sample supply part 71 has the plunger 71a. The sample supply part 71 is connected to the first valve 72 via the tube T1. The valve V1 of the first valve 72 is connected to the microchannel 100 via the tube T2.

One end of the tube T8 is coupled to the valve V2 of the first valve 72. The other end of the tube T8 is immersed in the dead volume countermeasure liquid OL in the second container 75.

In the first valve 72, the valve V1 is closed, and the valve V2 is open. In the present embodiment, the sample supply part 71 is empty before the filling operation of the dead volume countermeasure liquid OL is performed.

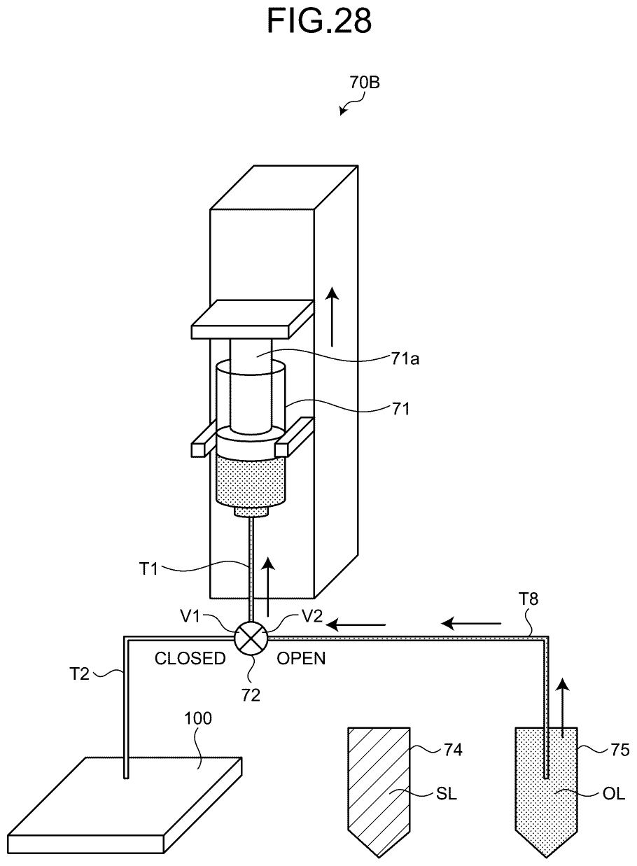

It is illustrated in FIG. 28 that the sample supply part 71 is in the state of being filled with the dead volume countermeasure liquid OL. As illustrated in FIG. 28, when the plunger 71a is pulled up by the liquid delivery drive source 81 being driven in the state illustrated in FIG. 27, the dead volume countermeasure liquid OL in the second container 75 is sucked through the tube T8 to be drawn into the tube T1. The sample supply part 71 is filled with the dead volume countermeasure liquid OL in the tube T1 by the plunger 71a being further pulled up.

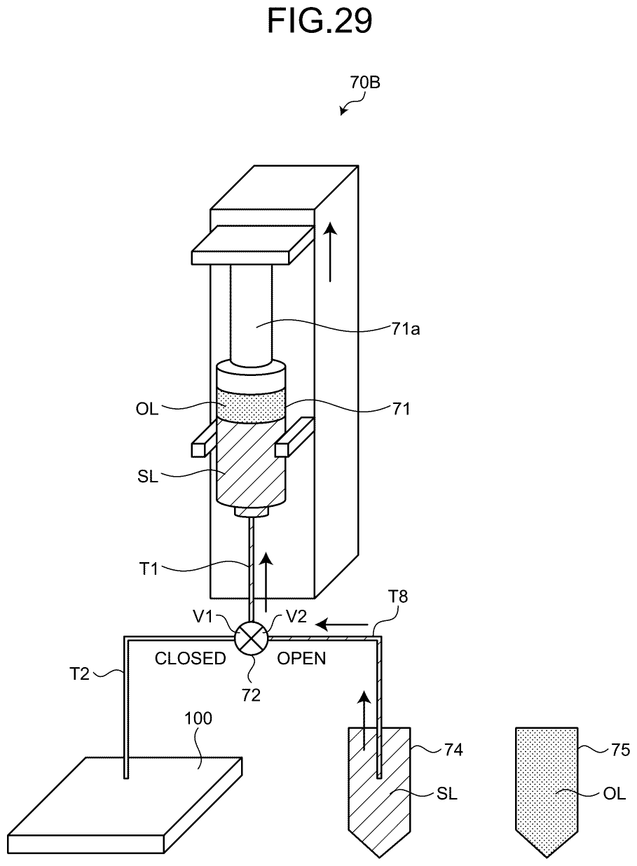

It is illustrated in FIG. 29 that the sample supply part 71 is in the state of being filled with the cell suspension SL. In a case of filling the sample supply part 71 with the cell suspension SL, the tube T8 is displaced from the second container 75 to the first container 74. The displacement of the tube T8 may be performed manually by the user under the direction of the control function 31B, or may be performed automatically by the control function 31B with the driving force of the motor or other components of the drive apparatus 80.

When the plunger 71a is pulled up by the liquid delivery drive source 81 being driven, in this state, the cell suspension SL in the first container 74 is sucked through the tube T8 to be drawn into the tube T1. The sample supply part 71 is filled with the cell suspension SL in the tube T1 by the plunger 71a being further pulled up.

In this example, the volume of the dead volume countermeasure liquid OL sucked and drawn into the sample supply part 71, the volume of the cell suspension SL sucked and drawn into the sample supply part 71, and the delivery flow rate are input by the user through the input apparatus 50.

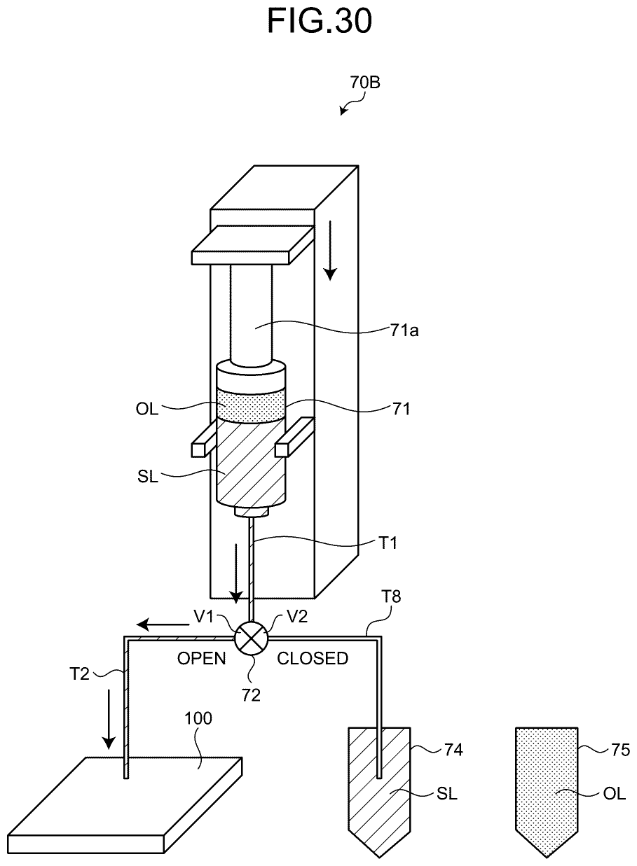

FIG. 30 illustrates an example of the liquid delivery apparatus 70B in the state of delivering the cell suspension SL into the microchannel 100. In a case in which the cell suspension SL is delivered into the microchannel 100, the control function 31B controls the valve drive source 82B to switch the valve V1 of the first valve 72 to be open and the valve V2 of the first valve 72 to be closed.

When the control function 31B drives the liquid delivery drive source 81, with the valve V1 of the first valve 72 opened and the valve V2 of the first valve 72 closed, the plunger 71a moves downwards to extrude the cell suspension SL from the sample supply part 71 into the tube T1, as illustrated in FIG. 30. As the plunger 71a further moves downwards, the cell suspension SL in the tube T1 is delivered through the tube T2 into the microchannel 100.

According to the present modification, it is also possible to deliver liquid continuously at a stable flow rate while controlling the dead volume, similarly to the third embodiment.

### Fifth Modification

The liquid delivery system 1 (1A and 1B) according to the first to third embodiments described above may have a filter inside the tube T (T1 and T2) connecting the sample supply part 71 and the microchannel 100 to each other to prevent the dead volume countermeasure liquid OL from entering the microchannel 100. For example, a membrane filter can be used as the filter.

The filter is preferably provided in the tube T at a position near a portion where the tube T and the microchannel 100 are coupled. This is because the following reason: the dead volume countermeasure liquid OL cannot reach the downstream from the position where the filter is provided in the tube T due to the filter; the cell suspension SL remaining downstream from the position where the filter is installed in the tube T thus cannot be extruded; therefore, the dead volume may occur at the downstream from the position where the filter is installed in the tube T.

According to the present modification, the dead volume countermeasure OL can be prevented from entering the microchannel 100, and the dead volume can be controlled while continuously delivering the liquid at a stable flow rate.

According to at least one of the embodiments described above, it is possible to control the occurrence of the dead volume while continuously delivering the liquid at a stable flow rate.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid delivery apparatus comprising:
a reservoir part configured to store therein a first liquid containing a specimen and a second liquid that is immiscible with the first liquid and has a different specific gravity from that of the first liquid;
a pipe one end of which is coupled to the reservoir part and the other end of which is coupled to a liquid delivery destination of the first liquid; and
a liquid delivery part configured to extrude the first liquid and the second liquid in this order from the reservoir part to the pipe to deliver the first liquid to the liquid delivery destination.

2. The liquid delivery apparatus according to claim 1, wherein
the liquid delivery part extrudes the second liquid with a specific gravity depending on a liquid delivery direction from the reservoir part to the liquid delivery destination into the pipe.

3. The liquid delivery apparatus according to claim 2, wherein
the second liquid having a greater specific gravity than that of the first liquid is extruded into the pipe in a case in which the liquid delivery direction is upward, and
the second liquid having a lower specific gravity than that of the first liquid is extruded into the pipe in a case in which the liquid delivery direction is downward.

4. The liquid delivery apparatus according to claim 1, further comprising
processing circuitry configured to
calculate a volume of the second liquid to be extruded from the reservoir part into the pipe based on information of the pipe, and
perform a control by which the liquid delivery part is controlled to extrude the second liquid equivalent to the calculated volume into the pipe.

5. The liquid delivery apparatus according to claim 4, wherein
the liquid delivery destination is microchannel.

6. The liquid delivery apparatus according to claim 5, wherein
the processing circuitry calculates a volume of the second liquid to be extruded from the reservoir part into the pipe and the microchannel based on information of the microchannel.

7. The liquid delivery apparatus according to claim 5, further comprising a filter provided in the pipe to prevent the second liquid delivered from the reservoir part from entering the microchannel.

8. The liquid delivery apparatus according to claim 7, wherein
the filter is provided in the tube at a position near a portion where the tube and the microchannel are coupled.

9. The liquid delivery apparatus according to claim 1, further comprising a first filling part configured to fill the reservoir part with the first liquid from a first container storing the first liquid.

10. The liquid delivery apparatus according to claim 9, further comprising a first switching part configured to switch between a state in which the first filling part can fill the reservoir part with the first liquid and a state in which the liquid delivery part is capable of delivering the first liquid to the liquid delivery destination.

11. The liquid delivery apparatus according to claim 10, further comprising:
a second filling part configured to fill the reservoir part with the second liquid from a second container storing the second liquid;
a second switching part configured to switch between a state in which the first filling part can fill the reservoir part with the first liquid and a state in which the second filling part can fill the reservoir part with the second liquid, wherein
the first switching part switches between the state in which the first filling part can fill the reservoir part with the first liquid or the state in which the second filling part can fill the reservoir part with the second liquid and the state in which the liquid delivery part is capable of delivering the first liquid to the liquid delivery destination.
